(19) United States
(12) Patent Application Publication
(10) Pub. No.: US 2011/0021404 A1
(43) Pub. Date: Jan. 27, 2011

(54) Surface Active Bleach and Dynamic pH

(76) Inventors: Edward M. Concar, San Francisco, CA (US); David A. Estell, San Francisco, CA (US); Hiroshi Oh, Cincinnati, OH (US); Ayrookaran J. Poulose, Belmont, CA (US)

Correspondence Address: JILL A. JACOBSON, PH.D.;DANISCO US INC., GENENCOR DIVISION, 925 PAGE MILL ROAD, Palo Alto,, CA, 94304-1013, US

(21) Appl. No.: 12/716,866

(22) Filed: Mar. 3, 2010

Related U.S. Application Data
(63) Continuation of application No. 11/707,307, filed on Feb. 16, 2007, now abandoned.
(60) Provisional application No. 60/779,130, filed on Mar. 2, 2006.

(51) Int. Cl. C11D 3/60; C11D 3/386

(52) U.S. Cl. 510/226; 510/220; 510/235; 510/276; 510/320; 510/392

(57) ABSTRACT

The present invention provides methods and compositions for dynamic pH control, particularly in detergent applications. In particularly preferred embodiments, the detergent compositions find use in surface removal of soils from fabrics, including clothing. In some particularly preferred embodiments, the present invention provides combinations of enzymes to provide for dynamic pH control.

### FIELD OF THE INVENTION

The present invention provides methods and compositions for dynamic pH control, particularly in detergent applications. In particularly preferred embodiments, the detergent compositions find use in surface removal of soils from fabrics, including clothing. In some particularly preferred embodiments, the present invention provides combinations of enzymes to provide for dynamic pH control.

### BACKGROUND OF THE INVENTION

Detergent and other cleaning compositions typically include a complex combination of active ingredients. For example, most cleaning products include a surfactant system, enzymes for cleaning, bleaching agents, builders, suds suppressors, soil-suspending agents, soil-release agents, optical brighteners, softening agents, dispersants, dye transfer inhibition compounds, abrasives, bactericides, and perfumes. Despite the complexity of current detergents, there are many stains that are difficult to completely remove. Furthermore, there is often residue build-up, which results in discoloration (e.g., yellowing) and diminished aesthetics due to incomplete cleaning. These problems are compounded by the increased use of low (e.g., cold water) wash temperatures and shorter washing cycles. Moreover, many stains are composed of complex mixtures of fibrous material, mainly incorporating carbohydrates and carbohydrate derivatives, fiber, and cell wall components (e.g., plant material, wood, mud/clay based soil, and fruit). These stains present difficult challenges to the formulation and use of cleaning compositions.

In addition, colored garments tend to wear and show appearance losses. A portion of this color loss is due to abrasion in the laundering process, particularly in automated washing and drying machines. Moreover, tensile strength loss of fabric appears to be an unavoidable result of mechanical and chemical action due to use, wearing, and/or washing and drying. Thus, a means to efficiently and effectively wash colored garments so that these appearance losses are minimized is needed.

In sum, despite improvements in the capabilities of cleaning compositions, there remains a need in the art for detergents that remove stains, maintain fabric color and appearance, and prevent dye transfer. In addition, there remains a need for detergent and/or fabric care compositions that provide and/or restore tensile strength, as well as provide anti-wrinkle, anti-bobbling, and/or anti-shrinkage properties to fabrics, as well as provide static control, fabric softness, maintain the desired color appearance, and fabric anti-wear properties and benefits. In particular, there remains a need for the inclusion of compositions that are capable of removing the colored components of stains, which often remain attached to the fabric being laundered. In addition, there remains a need for improved methods and compositions suitable for textile bleaching.

### SUMMARY OF THE INVENTION

The present invention provides methods and compositions for dynamic pH control, particularly in detergent applications. In particularly preferred embodiments, the detergent compositions find use in surface removal of soils from fabrics, including clothing. Dynamic pH control through the wash allows performance ingredients to fully utilize their potential in the suitable pH range to deliver superior cleaning benefits. In addition, pH changes of the washing solution (from weak alkaline pH to acidic pH) also denature soils on the surface and remove certain soils that are not removed at higher pHs.

The present invention further provides compositions comprising a sufficient amount of at least one enzyme and at least one substrate for the enzyme, sufficient to drop the pH of a wash liquor to at least about pH 7 or less. In some particularly preferred embodiments, the methods as set forth herein (e.g., Example 3) are used in order to assess the pH drop. In some preferred embodiments, the pH drop is to about pH 6 or less. In some alternative embodiments, the enzyme is selected from hydrolases and oxidases. In some preferred embodiments, the hydrolase is selected from perhydrolase, carboxylate ester hydrolase, thioester hydrolase, phosphate monoester hydrolase, phosphate diester hydrolase, thioether hydrolase, α-amino-acyl-peptide hydrolase, peptidyl-amino acid hydrolase, acyl-amino acid hydrolase, dipeptide hydrolase, peptidyl-peptide hydrolase, pepsin, pepsin B, rennin, trypsin, chymotrypsin A, chymotrypsin B, elastase, enterokinase, cathepsin C, papain, chymopapain, ficin, thrombin, fibrinolysin, renin, subtilisin, aspergillopeptidase A, collagenase, clostridiopeptidase B, kallikrein, gastrisin, cathepsin D, bromelin, keratinase, chymotrypsin C, pepsin C, aspergillopeptidase B, urokinase, carboxypeptidase A and B, aminopeptidase, lipase, pectin esterase, and chlorophyllase. In some particularly preferred embodiments, the hydrolase comprises at least one enzyme having perhydrolase activity (e.g., perhydrolases, as set forth herein). In yet additional embodiments, the oxidase is selected from aldose oxidase, galactose oxidase, cellobiose oxidase, pyranose oxidase, sorbose substrate comprises an ester moiety. In some preferred embodiments, the substrate comprising an ester moiety is selected from ethyl acetate, triacetin, tributyrin, neodol esters, ethoxylated neodol acetate esters, formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. In still further embodiments, the substrate comprising the ester moiety has the formula R¹Oₓ[(R²)ₘ(R³)ₙ]ₚ, wherein R¹ is H or a moiety that comprises a primary, secondary, tertiary or quaternary amine moiety, the R¹ moiety that comprises an amine moiety being selected from a substituted or unsubstituted alkyl, heteroalkyl, alkenyl, alkynyl, aryl, alkylaryl, alkylheteroaryl, and heteroaryl; or wherein R¹ comprises from 1 to 50,000 carbon atoms, from 1 to 10,000 carbon atoms, or even from 2 to 100 carbon atoms; each R² is an alkoxylate moiety, in one aspect of the present invention each R² is independently an ethoxylate, propoxylate or butoxylate moiety; R³ is an ester-forming moiety having the formula: R⁴CO— wherein R⁴ may be H, substituted or unsubstituted alkyl, alkenyl, alkynyl, aryl, alkylaryl, alkylheteroaryl, and heteroaryl, in one aspect of the present invention, R⁴ may be a substituted or unsubstituted alkyl, alkenyl, or alkynyl moiety comprising from 1 to 22 carbon atoms, a substituted or unsubstituted aryl, alkylaryl, alkylheteroaryl, or heteroaryl moiety comprising from 4 to 22 carbon atoms or R⁴ may be a substituted or unsubstituted C₁-C₂₂ alkyl moiety or R⁴ may be a substituted or unsubstituted C₁-C₁₂ alkyl moiety; x is 1 when R¹ is H; when R¹ is not H, x is an integer that is equal to or less than the number of carbons in R¹, p is an integer that is equal to or less than x, m is an integer from 0 to 12 or even 1 to 12, and n is at least 1. In yet additional embodiments, the compositions set forth herein comprise, based on total composition weight, from about 0.01 to about 99.9 of the substrate comprising an ester moiety. In some preferred embodiments, the compositions comprise, based on total composition weight, from about 0.1 to about 50 of the substrate comprising an ester moiety. In still further preferred embodiments, the compositions further comprise at least one source of hydrogen peroxide and/or hydrogen peroxide. In some preferred embodiments, the compositions further comprise at least one adjunct ingredient. In some particularly preferred embodiments, the at least one adjunct ingredient is selected from surfactants, builders, chelating agents, dye transfer inhibiting agents, deposition aids, dispersants, additional enzymes, and enzyme stabilizers, catalytic materials, bleach activators, bleach boosters, preformed peracids, polymeric dispersing agents, clay soil removal/anti-redeposition agents, brighteners, suds suppressors, dyes, perfumes, structure elasticizing agents, fabric softeners, carriers, hydrotropes, processing aids and/or pigments.

The present invention also provides methods for cleaning at least a portion of a surface and/or fabric comprising: the optional steps of washing and/or rinsing a surface and/or fabric; contacting the surface and/or fabric with at least one of the compositions set forth herein and/or a wash liquor comprising at least one of the compositions set forth herein; and optionally washing and/or rinsing the surface and/or fabric. In some preferred embodiments, the pH of the wash liquor drops essentially linearly. In still further embodiments, the surface and/or fabric is exposed to the wash liquor having a pH of less than about 6.5 for a period of at least about 2 minutes.

The present invention further provides methods for cleaning at least a portion of a surface and/or fabric comprising: the optional steps of washing and/or rinsing a surface and/or fabric; contacting the surface and/or fabric with at least one composition set forth herein and/or a wash liquor comprising at least one composition set forth herein; and optionally washing and/or rinsing the surface and/or fabric, wherein the contacting occurs during a wash cycle. In some preferred embodiments, the pH of the wash liquor drops essentially linearly. In some particularly preferred embodiments, the pH of the wash liquor drops to 6.5 or less within the last 25% to 50% of the wash cycle. In additional embodiments, the surface and/or fabric is exposed to the wash liquor having a pH of less than about 6.5 for a period of at least about 2 minutes.

### DESCRIPTION OF THE FIGURES

FIG. 1 provides graphs showing the effects of pH on cleaning performance with peracetic acid. Panel A provides results for T-shirts, while Panel B provides results for pillowcases, and Panel C provides results for tea stains.

FIG. 2 provides a graph showing the titration curve for dingy ballast.

FIG. 3 provides graphs showing substrate and enzyme parameters involved in generating a dynamic pH performance benefit. Panel A provides a graph showing the pH profile of treatments, while Panel B provides data for T-shirts, pillowcases, containing hydrophobic soil, and the average of such data, and Panel C provides data for wine, tea, containing hydrophilic soils and the average of such data.

FIG. 4 provides graphs showing results of experiments conducted to determine the effects of substrates and cleaning performance. Panel A provides a graph showing the pH profile of treatments, while Panel B provides data for T-shirts, pillowcases, containing hydrophobic soil, and the average of such data, and Panel C provides data for wine, tea, containing hydrophilic soils and the average of such data.

FIG. 5 provides graphs showing comparisons of cleaning performance of a dynamic pH detergent and commercial detergents. Panel A provides a graph showing the pH profile of treatments, while Panel B provides data for T-shirts, pillowcases, containing hydrophobic soil, and the average of such data, and Panel C provides data for wine, tea, and containing hydrophilic soils and the average of such data.

### DESCRIPTION OF THE INVENTION

The present invention provides methods and compositions for dynamic pH control, particularly in detergent applications. In particularly preferred embodiments, the detergent compositions find use in surface removal of soils from fabrics, including clothing. In some particularly preferred embodiments, the present invention provides combinations of enzymes to provide for dynamic pH control throughout the washing cycle.

Unless otherwise indicated, the practice of the present invention involves conventional techniques commonly used in molecular biology, microbiology, protein purification, protein engineering, protein and DNA sequencing, and recombinant DNA fields, which are within the skill of the art. Such techniques are known to those of skill in the art and are described in numerous texts and reference works (See e.g., Sambrook et al., Molecular Cloning: A Laboratory Manual, 2^{nd} ed., Cold Spring Harbor, [1989]); and Ausubel et al., Current Protocols in Molecular Biology, [1987]). All patents, patent applications, articles and publications mentioned herein, both supra and infra, are hereby expressly incorporated herein by reference.

Furthermore, the headings provided herein are not limitations of the various aspects or embodiments of the invention which can be had by reference to the specification as a whole. Accordingly, the terms defined immediately below are more fully defined by reference to the specification as a whole. Nonetheless, in order to facilitate understanding of the invention, a number of terms are defined below.

### DEFINITIONS

Unless defined otherwise herein, all technical and scientific terms used herein have the same meaning as commonly understood by one of ordinary skill in the art to which this invention pertains. For example, Singleton and Sainsbury, Dictionary of Microbiology and Molecular Biology, 2d Ed., John Wiley and Sons, NY (1994); and Hale and Marham, The Harper Collins Dictionary of Biology, Harper Perennial, N.Y. (1991) provide those of skill in the art with a general dictionaries of many of the terms used in the invention. Although any methods and materials similar or equivalent to those described herein find use in the practice of the present invention, the preferred methods and materials are described herein. Accordingly, the terms defined immediately below are more fully described by reference to the Specification as a whole. Also, as used herein, the singular terms “a”, “an,” and “the” include the plural reference unless the context clearly indicates otherwise. Unless otherwise indicated, nucleic acids are written left to right in 5′ to 3′ orientation; amino acid sequences are written left to right in amino to carboxy orientation, respectively. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the term “dynamic pH” refers to a change in the pH of a cleaning system during cleaning that is due to the action of at least one enzyme on at least one substrate present in the cleaning system. In particularly preferred embodiments, the dynamic pH condition results in cleaning benefits, such as improved wash performance of detergents.

As used herein, the term “bleaching” refers to the treatment of a material (e.g., fabric, laundry, etc.) or surface for a sufficient length of time and under appropriate pH and temperature conditions to effect a brightening (i.e., whitening) and/or cleaning of the material. Examples of chemicals suitable for bleaching include but are not limited to ClO₂, H₂O₂, peracids, NO₂, etc.

As used herein, the term “disinfecting” refers to the removal of contaminants from the surfaces, as well as the inhibition or killing of microbes on the surfaces of items. It is not intended that the present invention be limited to any particular surface, item, or contaminant(s) or microbes to be removed.

As used herein, the term “perhydrolase” refers to an enzyme that is capable of catalyzing a reaction that results in the formation of sufficiently high amounts of peracid suitable for applications such as cleaning, bleaching, and disinfecting. In particularly preferred embodiments, the perhydrolase enzymes of the present invention produce very high perhydrolysis to hydrolysis ratios. The high perhydrolysis to hydrolysis ratios of these distinct enzymes makes these enzymes suitable for use in a very wide variety of applications. In additional preferred embodiments, the perhydrolases of the present invention are characterized by having distinct tertiary structure and primary sequence. In particularly preferred embodiments, the perhydrolases of the present invention comprises distinct primary and tertiary structures. In some particularly preferred embodiments, the perhydrolases of the present invention comprise distinct quaternary structure. In some preferred embodiments, the perhydrolase of the present invention is the M. smegmatis perhydrolase, while in alternative embodiments, the perhydrolase is a variant of this perhydrolase, while in still further embodiments, the perhydrolase is a homolog of this perhydrolase. In further preferred embodiments, a monomeric hydrolase is engineered to produce a multimeric enzyme that has better perhydrolase activity than the monomer. However, it is not intended that the present invention be limited to this specific M. smegmatis perhydrolase, specific variants of this perhydrolase, nor specific homologs of the perhydrolase provided in US04/40438, incorporated herein by reference in its entirety.

As used herein, “personal care products” means products used in the cleaning, bleaching and/or disinfecting of hair, skin, scalp, and teeth, including, but not limited to shampoos, body lotions, shower gels, topical moisturizers, toothpaste, and/or other topical cleansers. In some particularly preferred embodiments, these products are utilized on humans, while in other embodiments, these products find use with non-human animals (e.g., in veterinary applications).

As used herein, “cleaning compositions” and “cleaning formulations” refer to compositions that find use in the removal of undesired compounds from items to be cleaned, such as fabric, dishes, contact lenses, other solid substrates, hair (shampoos), skin (soaps and creams), teeth (mouthwashes, toothpastes) etc. The term encompasses any materials/compounds selected for the particular type of cleaning composition desired and the form of the product (e.g., liquid, gel, granule, or spray composition), as long as the composition is compatible with the perhydrolase and other enzyme(s) used in the composition. The specific selection of cleaning composition materials are readily made by considering the surface, item or fabric to be cleaned, and the desired form of the composition for the cleaning conditions during use.

The terms further refer to any composition that is suited for cleaning, bleaching, disinfecting, and/or sterilizing any object and/or surface. It is intended that the terms include, but are not limited to detergent compositions (e.g., liquid and/or solid laundry detergents and fine fabric detergents; hard surface cleaning formulations, such as for glass, wood, ceramic and metal counter tops and windows; carpet cleaners; oven cleaners; fabric fresheners; fabric softeners; and textile and laundry pre-spotters, as well as dish detergents).

Indeed, the term “cleaning composition” as used herein, includes unless otherwise indicated, granular or powder-form all-purpose or heavy-duty washing agents, especially cleaning detergents; liquid, gel or paste-form all-purpose washing agents, especially the so-called heavy-duty liquid (HDL) types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the terms “detergent composition” and “detergent formulation” are used in reference to mixtures which are intended for use in a wash medium for the cleaning of soiled objects. In some preferred embodiments, the term is used in reference to laundering fabrics and/or garments (e.g., “laundry detergents”). In alternative embodiments, the term refers to other detergents, such as those used to clean dishes, cutlery, etc. (e.g., “dishwashing detergents”). It is not intended that the present invention be limited to any particular detergent formulation or composition. Indeed, it is intended that in addition to perhydrolase, the term encompasses detergents that contain surfactants, transferase(s), hydrolytic enzymes, oxido reductases, builders, bleaching agents, bleach activators, bluing agents and fluorescent dyes, caking inhibitors, masking agents, enzyme activators, antioxidants, and solubilizers.

As used herein, “enhanced performance” in a detergent is defined as increasing cleaning of bleach-sensitive stains (e.g., grass, tea, wine, blood, dingy, etc.), as determined by usual evaluation after a standard wash cycle. In particular embodiments, the enzymes of the present invention provide enhanced performance in the oxidation and removal of colored stains and soils. In further embodiments, the enzymes of the present invention provide enhanced performance in the removal and/or decolorization of stains. In yet additional embodiments, the enzymes of the present invention provides enhanced performance in the removal of lipid-based stains and soils. In still further embodiments, the present invention provides enhanced performance in removing soils and stains from dishes and other items.

As used herein the term “hard surface cleaning composition,” refers to detergent compositions for cleaning hard surfaces such as floors, walls, tile, bath and kitchen fixtures, and the like. Such compositions are provided in any form, including but not limited to solids, liquids, emulsions, etc.

As used herein, “dishwashing composition” refers to all forms for compositions for cleaning dishes, including but not limited to granular and liquid forms.

As used herein, “fabric cleaning composition” refers to all forms of detergent compositions for cleaning fabrics, including but not limited to, granular, liquid and bar forms.

As used herein, “textile” refers to woven fabrics, as well as staple fibers and filaments suitable for conversion to or use as yarns, woven, knit, and non-woven fabrics. The term encompasses yarns made from natural, as well as synthetic (e.g., manufactured) fibers.

As used herein, “textile materials” is a general term for fibers, yarn intermediates, yarn, fabrics, and products made from fabrics (e.g., garments and other articles).

As used herein, “fabric” encompasses any textile material. Thus, it is intended that the term encompass garments, as well as fabrics, yarns, fibers, non-woven materials, natural materials, synthetic materials, and any other textile material.

As used herein, the term “compatible,” means that the cleaning composition materials do not reduce the enzymatic activity of the perhydrolase to such an extent that the perhydrolase is not effective as desired during normal use situations. Specific cleaning composition materials are exemplified in detail hereinafter.

As used herein, “effective amount of enzyme” refers to the quantity of enzyme necessary to achieve the enzymatic activity required in the specific application. Such effective amounts are readily ascertained by one of ordinary skill in the art and are based on many factors, such as the particular enzyme variant used, the cleaning application, the specific composition of the cleaning composition, and whether a liquid or dry (e.g., granular, bar) composition is required, and the like.

As used herein, “non-fabric cleaning compositions” encompass hard surface cleaning compositions, dishwashing compositions, and personal care cleaning compositions (e.g., oral cleaning compositions, denture cleaning compositions, personal cleansing compositions, etc.).

As used herein, “oral cleaning compositions” refers to dentifrices, toothpastes, toothgels, toothpowders, mouthwashes, mouth sprays, mouth gels, chewing gums, lozenges, sachets, tablets, biogels, prophylaxis pastes, dental treatment solutions, and the like. Oral care compositions that find use in conjunction with the perhydrolases of the present invention are well known in the art (See e.g., U.S. Pat. Nos. 5,601,750, 6,379,653, and 5,989,526, all of which are incorporated herein by reference).

As used herein, “oxidizing chemical” refers to a chemical that has the capability of bleaching any material. The oxidizing chemical is present at an amount, pH and temperature suitable for bleaching. The term includes, but is not limited to hydrogen peroxide and peracids.

As used herein, “acyl” is the general name for organic acid groups, which are the residues of carboxylic acids after removal of the —OH group (e.g., ethanoyl chloride, CH₃CO—Cl, is the acyl chloride formed from ethanoic acid, CH₃COO—H). The names of the individual acyl groups are formed by replacing the “-ic” of the acid by “-yl.”

As used herein, the term “acylation” refers to the chemical transformation which substitutes the acyl (RCO—) group into a molecule, generally for an active hydrogen of an —OH group.

As used herein, the term “transferase” refers to an enzyme that catalyzes the transfer of functional compounds to a range of substrates.

As used herein, “leaving group” refers to the nucleophile which is cleaved from the acyl donor upon substitution by another nucleophile.

As used herein, the term “enzymatic conversion” refers to the modification of a substrate to an intermediate or the modification of an intermediate to an end-product by contacting the substrate or intermediate with an enzyme. In some embodiments, contact is made by directly exposing the substrate or intermediate to the appropriate enzyme. In other embodiments, contacting comprises exposing the substrate or intermediate to an organism that expresses and/or excretes the enzyme, and/or metabolizes the desired substrate and/or intermediate to the desired intermediate and/or end-product, respectively.

As used herein, the phrase “detergent stability” refers to the stability of a detergent composition. In some embodiments, the stability is assessed during the use of the detergent, while in other embodiments, the term refers to the stability of a detergent composition during storage.

As used herein, the phrase, “stability to proteolysis” refers to the ability of a protein (e.g., an enzyme) to withstand proteolysis. It is not intended that the term be limited to the use of any particular protease to assess the stability of a protein.

As used herein, “oxidative stability” refers to the ability of a protein to function under oxidative conditions. In particular, the term refers to the ability of a protein to function in the presence of various concentrations of H₂O₂ and/or peracid. Stability under various oxidative conditions can be measured either by standard procedures known to those in the art and/or by the methods described herein. A substantial change in oxidative stability is evidenced by at least about a 5% or greater increase or decrease (in most embodiments, it is preferably an increase) in the half-life of the enzymatic activity, as compared to the enzymatic activity present in the absence of oxidative compounds.

As used herein, “pH stability” refers to the ability of a protein to function at a particular pH. In general, most enzymes have a finite pH range at which they will function. In addition to enzymes that function in mid-range pHs (i.e., around pH 7), there are enzymes that are capable of working under conditions with very high or very low pHs. Stability at various pHs can be measured either by standard procedures known to those in the art and/or by the methods described herein. A substantial change in pH stability is evidenced by at least about 5% or greater increase or decrease (in most embodiments, it is preferably an increase) in the half-life of the enzymatic activity, as compared to the enzymatic activity at the enzyme's optimum pH. However, it is not intended that the present invention be limited to any pH stability level nor pH range.

As used herein, “thermal stability” refers to the ability of a protein to function at a particular temperature. In general, most enzymes have a finite range of temperatures at which they will function. In addition to enzymes that work in mid-range temperatures (e.g., room temperature), there are enzymes that are capable of working in very high or very low temperatures. Thermal stability can be measured either by known procedures or by the methods described herein. A substantial change in thermal stability is evidenced by at least about 5% or greater increase or decrease (in most embodiments, it is preferably an increase) in the half-life of the catalytic activity of a mutant when exposed to a different temperature (i.e., higher or lower) than optimum temperature for enzymatic activity. However, it is not intended that the present invention be limited to any temperature stability level nor temperature range.

As used herein, the term “chemical stability” refers to the stability of a protein (e.g., an enzyme) towards chemicals that adversely affect its activity. In some embodiments, such chemicals include, but are not limited to hydrogen peroxide, peracids, anionic detergents, cationic detergents, non-ionic detergents, chelants, etc. However, it is not intended that the present invention be limited to any particular chemical stability level nor range of chemical stability.

As used herein, the phrase “alteration in substrate specificity” refers to changes in the substrate specificity of an enzyme. In some embodiments, a change in substrate specificity is defined as a difference between the K_{cat}/Kₘ ratio observed with an enzyme compared to enzyme variants or other enzyme compositions. Enzyme substrate specificities vary, depending upon the substrate tested. The substrate specificity of an enzyme is determined by comparing the catalytic efficiencies it exhibits with different substrates. These determinations find particular use in assessing the efficiency of mutant enzymes, as it is generally desired to produce variant enzymes that exhibit greater ratios for particular substrates of interest. For example, the perhydrolase enzymes of the present invention are more efficient in producing peracid from an ester substrate than enzymes currently being used in cleaning, bleaching and disinfecting applications. Another example of the present invention is a perhydrolase with a lower activity on peracid degradation compared to the wild type. Another example of the present invention is a perhydrolase with higher activity on more hydrophobic acyl groups than acetic acid. However, it is not intended that the present invention be limited to any particular substrate composition nor any specific substrate specificity.

As used herein, the phrase “is independently selected from the group consisting of . . . ” means that moieties or elements that are selected from the referenced Markush group can be the same, can be different or any mixture of elements as indicated in the following example:

In reference to chemical compositions, the term “substituted” as used herein, means that the organic composition or radical to which the term is applied is:
(a) made unsaturated by the elimination of at least one element or radical; or
(b) at least one hydrogen in the compound or radical is replaced with a moiety containing one or more (i) carbon, (ii) oxygen, (iii) sulfur, (iv) nitrogen or (v) halogen atoms; or
(c) both (a) and (b).

Moieties which may replace hydrogen as described in (b) immediately above, that contain only carbon and hydrogen atoms, are hydrocarbon moieties including, but not limited to, alkyl, alkenyl, alkynyl, alkyldienyl, cycloalkyl, phenyl, alkyl phenyl, naphthyl, anthryl, phenanthryl, fluoryl, steroid groups, and combinations of these groups with each other and with polyvalent hydrocarbon groups such as alkylene, alkylidene and alkylidyne groups. Moieties containing oxygen atoms that may replace hydrogen as described in (b) immediately above include, but are not limited to, hydroxy, acyl or keto, ether, epoxy, carboxy, and ester containing groups. Moieties containing sulfur atoms that may replace hydrogen as described in (b) immediately above include, but are not limited to, the sulfur-containing acids and acid ester groups, thioether groups, mercapto groups and thioketo groups. Moieties containing nitrogen atoms that may replace hydrogen as described in (b) immediately above include, but are not limited to, amino groups, the nitro group, azo groups, ammonium groups, amide groups, azido groups, isocyanate groups, cyano groups and nitrile groups. Moieties containing halogen atoms that may replace hydrogen as described in (b) immediately above include chloro, bromo, fluoro, iodo groups and any of the moieties previously described where a hydrogen or a pendant alkyl group is substituted by a halo group to form a stable substituted moiety.

It is understood that any of the above moieties (b)(i) through (b)(v) can be substituted into each other in either a monovalent substitution or by loss of hydrogen in a polyvalent substitution to form another monovalent moiety that can replace hydrogen in the organic compound or radical.

As used herein, the terms “purified” and “isolated” refer to the removal of contaminants from a sample. For example, an enzyme of interest is purified by removal of contaminating proteins and other compounds within a solution or preparation that are not the enzyme of interest. In some embodiments, recombinant enzymes of interest are expressed in bacterial or fungal host cells and these recombinant enzymes of interest are purified by the removal of other host cell constituents; the percent of recombinant enzyme of interest polypeptides is thereby increased in the sample.

As used herein, “protein of interest,” refers to a protein (e.g., an enzyme or “enzyme of interest”) which is being analyzed, identified and/or modified. Naturally-occurring, as well as recombinant proteins find use in the present invention.

As used herein, “protein” refers to any composition comprised of amino acids and recognized as a protein by those of skill in the art. The terms “protein,” “peptide” and polypeptide are used interchangeably herein. Wherein a peptide is a portion of a protein, those skilled in the art understand the use of the term in context.

As used herein, functionally and/or structurally similar proteins are considered to be “related proteins.” In some embodiments, these proteins are derived from a different genus and/or species, including differences between classes of organisms (e.g., a bacterial protein and a fungal protein). In some embodiments, these proteins are derived from a different genus and/or species, including differences between classes of organisms (e.g., a bacterial enzyme and a fungal enzyme). In additional embodiments, related proteins are provided from the same species. Indeed, it is not intended that the present invention be limited to related proteins from any particular source(s). In addition, the term “related proteins” encompasses tertiary structural homologs and primary sequence homologs (e.g., the enzymes of the present invention). In further embodiments, the term encompasses proteins that are immunologically cross-reactive. In some most particularly preferred embodiments, the related proteins of the present invention exhibit very high ratios of perhydrolysis to hydrolysis.

### Cleaning and Detergent Formulations

The detergent compositions of the present invention are provided in any suitable form, including for example, as a liquid diluent, in granules, in emulsions, in gels, and pastes. When a solid detergent composition is employed, the detergent is preferably formulated as granules. Preferably, the granules are formulated to additionally contain a protecting agent (See e.g., U.S. application Ser. No. 07/642,669 filed Jan. 17, 1991, incorporated herein by reference). Likewise, in some embodiments, the granules are formulated so as to contain materials to reduce the rate of dissolution of the granule into the wash medium (See e.g., U.S. Pat. No. 5,254,283, incorporated herein by reference in its entirety). In addition, the perhydrolase enzymes of the present invention find use in formulations in which substrate and enzyme are present in the same granule. Thus, in some embodiments, the efficacy of the enzyme is increased by the provision of high local concentrations of enzyme and substrate (See e.g., U.S. Patent Application Publication US2003/0191033, herein incorporated by reference).

Many of the enzymes and enzyme variants that find use in the present invention are useful in formulating various detergent compositions. A number of known compounds are suitable surfactants useful in these compositions. These include nonionic, anionic, cationic, anionic or zwitterionic detergents (See e.g., U.S. Pat. Nos. 4,404,128 and 4,261,868). A suitable detergent formulation is that described in U.S. Pat. No. 5,204,015 (previously incorporated by reference). Those in the art are familiar with the different formulations which find use as cleaning compositions.

As indicated herein, in some preferred embodiments, the detergent compositions of the present invention employ a surface active agent (i.e., surfactant) including anionic, non-ionic and ampholytic surfactants well known for their use in detergent compositions. Some surfactants suitable for use in the present invention are described in British Patent Application No. 2 094 826 A, incorporated herein by reference. In some embodiments, mixtures surfactants are used in the present invention.

Suitable anionic surfactants for use in the detergent composition of the present invention include linear or branched alkylbenzene sulfonates; alkyl or alkenyl ether sulfates having linear or branched alkyl groups or alkenyl groups; alkyl or alkenyl sulfates; olefin sulfonates; alkane sulfonates and the like. Suitable counter ions for anionic surfactants include alkali metal ions such as sodium and potassium; alkaline earth metal ions such as calcium and magnesium; ammonium ion; and alkanolamines having 1 to 3 alkanol groups of carbon number 2 or 3.

Ampholytic surfactants that find use in the present invention include quaternary ammonium salt sulfonates, betaine-type ampholytic surfactants, and the like. Such ampholytic surfactants have both the positive and negative charged groups in the same molecule.

Nonionic surfactants that find use in the present invention generally comprise polyoxyalkylene ethers, as well as higher fatty acid alkanolamides or alkylene oxide adduct thereof, fatty acid glycerine monoesters, and the like.

In some preferred embodiments, the surfactant or surfactant mixture included in the detergent compositions of the present invention is provided in an amount from about 1 weight percent to about 95 weight percent of the total detergent composition and preferably from about 5 weight percent to about 45 weight percent of the total detergent composition. In various embodiments, numerous other components are included in the compositions of the present invention. Many of these are described below. It is not intended that the present invention be limited to these specific examples. Indeed, it is contemplated that additional compounds will find use in the present invention. The descriptions below merely illustrate some optional components.

Proteins, particularly the perhydrolase and/or other enzyme(s) of the present invention are typically formulated into known powdered and liquid detergents having pH between 3 and 12.0, at levels of about 0.001 to about 5% (preferably 0.1% to 0.5%) by weight. In some embodiments, these detergent cleaning compositions further include other enzymes (e.g., proteases, amylases, mannanases, peroxidases, oxido reductases, cellulases, lipases, cutinases, pectinases, pectin lyases, xylanases, and/or endoglycosidases), as well as builders and stabilizers. Indeed, it is contemplated that any enzyme with hydrolyzing activity will find use alone and/or in combination with other enzymes in the present invention.

In addition to typical cleaning compositions, it is readily understood that perhydrolase variants of the present invention find use in any purpose that the native or wild-type enzyme is used. Thus, such variants can be used, for example, in bar and liquid soap applications, dish care formulations, surface cleaning applications, contact lens cleaning solutions or products, waste treatment, textile applications, disinfectants, skin care, oral care, hair care, etc. Indeed, it is not intended that any variants of the perhydrolase of the present invention be limited to any particular use. For example, the variant perhydrolases of the present invention may comprise, in addition to decreased allergenicity, enhanced performance in a detergent composition (as compared to the wild-type or unmodified perhydrolase).

The addition of proteins to conventional cleaning compositions does not create any special use limitations. In other words, any temperature and pH suitable for the detergent are also suitable for the present compositions, as long as the pH is within the range in which the enzyme(s) is/are active, and the temperature is below the described protein's denaturing temperature. In addition, proteins of the invention find use in cleaning, bleaching, and disinfecting compositions without detergents, again either alone or in combination with a source of hydrogen peroxide, an ester substrate (e.g., either added or inherent in the system utilized, such as with stains that contain esters, that contains esters etc), other enzymes, surfactants, builders, stabilizers, etc. Indeed it is not intended that the present invention be limited to any particular formulation or application.

### DETAILED DESCRIPTION OF THE PRESENT INVENTION

The present invention provides methods and compositions for dynamic pH control, particularly in detergent applications. In particularly preferred embodiments, the detergent compositions find use in surface removal of soils from fabrics, including clothing. In some particularly preferred embodiments, the present invention provides combinations of enzymes to provide for dynamic pH control. Indeed, it is contemplated that any enzyme with hydrolyzing or perhydrolyzing activity will find use alone and/or in combination with other enzymes in the present invention.

It is well known to launder fabrics in automatic washing machines. Standard automatic washing machine operation includes at least one wash cycle, at least one spin cycle which removes significant portions of the washing liquor from the wash cycle, a final rinse cycle, and a final spin cycle.

Cleaning agents (e.g., surfactants and detergent builders are commonly added to the washing machine drum during the wash and/or rinse cycle to assist in the removal of soils and stains from fabrics. However, additional materials, such as fabric care benefit agents (e.g., softeners, feel modifiers, anti-wrinkling agents, etc.), are sometimes added to a wash load during the rinse cycle and not the wash cycle, in order to avoid interference from components present in the wash liquor. Some of these materials (e.g., perfumes, brightening agents, fabric care benefit agents, and/or soil release agents) are deposited on the fabric, in order to provide maximum benefit. In some cases, it is desirable to maximize the potential deposition of these materials on the fabrics.

The pH of the aqueous wash liquor during the start of the wash cycle is generally high, typically above 7, and most commonly at least 9. Indeed, it is often in the range of 10.5 to 12.5, and is sometimes even higher. However, in some embodiments of the present invention, the desired end pH is less than or equal to 6. Due to the different natures of the additives commonly included in the wash and/or rinse cycle and the removal of the majority of the wash liquor, the pH of the rinse cycle is generally lower than that of the wash cycle, but it is not usually lower than 7. Although rinse cycles with pHs below pH 7 have been used, this is not common practice. Automatic washing machine processes have special requirements in that it is usual to include a complex detergent composition in the wash cycle and it is also common to include a variety of fabric types in a single wash load.

Laundry wash compositions need to be technically and economically attractive, as well as acceptable to the consumer. In particular, removal of greasy stains and/or bleachable stains represents a continuing challenge to formulators of laundry detergents. Although this is an area that needs improvement, the types of components in laundry washing compositions that effectively improve performance tend to be some of the most expensive components (e.g., bleach). The present invention provides compositions and methods to improve the performance of laundry detergents in a cost-effective manner.

In addition, the present invention provides compositions and methods suitable for the effective cleaning of dingy items. A problem which occurs with automatic washing machine processing involves the gradual deposition of residues on fabrics over a number of washes. In addition, during wearing, there are significant amount of body soils and environmental soils deposited on fabrics that further build the residual soils. These residues often lead to the dulling of dark-colored fabrics and/or imparting a “dingy” appearance in white and/or other light-colored fabrics. This deposition of residues also makes removal of stains from fabric surfaces more difficult. The present invention finds use in treating dingy fabrics and cleaning them more effectively than current compositions.

As the optimal pH values of different actives in laundry detergents vary greatly, as do the pH-dependent performance on cleaning of soiled fabric, compositions are needed that can effectively work under a wide variety of pH conditions to clean soiled fabric. The perhydrolase enzyme of the present invention used in some embodiments of the present invention, finds use in the generation of peracid bleach and pH-lowering acids from ester substrates. In some embodiments, these ester substrates are present in the soil, while in other embodiments, they are added to the composition and/or wash load. In particularly preferred embodiments, surface active esters adsorb to the fabric and stain surface, in order to provide targeted bleaching. Thus, enzymes such as those provided by the present invention that have great affinity for the stain and/or fabric surfaces facilitate surface-localized bleach and/or acid formation. Formulae that have moderate alkalinity allow for greater activity and solubility of specific components (e.g., peracids), with pKas of around 8.2 and surfactants. Hydrolase cleavage of esters generates acid, which reduces the pH, solubilizing fatty residues and improving the performance of laundry components with optimal activities at acidic pHs.

In some particularly preferred embodiments, perhydrolase, surfactant esters, triacetin, peroxide, and a minimal surfactant base find use in cleaning soiled articles. In some embodiments, the soils primarily comprise body soils. In some embodiments, the soiled fabric is titrated such that an appropriate buffering system is provided, in order to provide an alkaline pH, yet with enough capacity to allow for a pH drop due to enzymatic acid production. As indicated herein, performance tests were conducted in miniwashers under North American median wash conditions. The enzymatic bleaching and dynamic pH formula provided by the present invention performed better than commercial liquid detergent on articles containing body soil. In some more preferred embodiments, the addition of the enzyme is delayed by 5 minutes (i.e., hydrolase was added after 5 minutes of a 12 minute wash cycle), while the substrate and perhydrolase were added to the wash load at the start of the wash cycle.

In some embodiments, the present invention finds use in the enzymatic generation of peracids from ester substrates and hydrogen peroxide. In some preferred embodiments, the substrates are selected from one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. Importantly, the present invention provides means for effective cleaning, bleaching, and disinfecting over broad pH and temperature ranges. In some embodiments, the pH range utilized in this generation is 4-12. In alternative embodiments, the temperature range utilized is between 5° and 90° C. The present invention provides advantages over the presently used systems (See e.g., EP Appln. 87-304933.9) in that bleaching is possible at the optimum pH of peracid oxidation, as well as providing bleaching at neutral pH, acidic pHs, and at low temperatures. While the present invention is described herein most fully in regard to laundry and fabric care, it is not intended that the present invention be limited to these applications. Indeed, the present invention finds use in various settings, particularly those in which bleaching by peracids and/or hydrogen peroxide are desired under dynamic pH conditions, including but not limited to laundry, fabric treatment, personal care applications, disinfection and cleaning of hard surfaces.

Historically, sodium perborate, and more recently, sodium percarbonate, have been used as bleaching compounds, particularly in laundry detergents. This compound decomposes rapidly in aqueous solution to yield hydrogen peroxide (H₂O₂), which is the active bleaching species. As sodium perborate is more active at temperatures above 80° C., and less active in the temperature range of 40-60° C. (i.e., wash temperatures that have become most commonly preferred as of the 1950s), bleaching activators have been incorporated into laundry detergents that contain sodium perborate. Indeed, most laundry detergents contain bleaching activators. These activators are compounds with O— or N— bounded acetyl groups that are able to react with the strongly nucleophilic hydroperoxy anion to yield peroxyacetic acid. Since the reacting species is hydroperoxy anion, alkaline pHs are essential for the efficient conversion of these activators to peracids. The peroxyacetic acid is decomposed in weakly basic media to form singlet oxygen (See, Hofmann et al., J. Prakt. Chem., 334:293-297 [1992]).

Hydrogen peroxide is a particularly effective bleach at high temperatures (e.g., >40° C.) and pH (>10), conditions that are typically used in washing fabrics in some settings. However, as indicated above, cold water washing is becoming more commonly used and results in less effective bleaching by H₂O₂ than use of hot water. To overcome this low temperature disadvantage, detergent formulations typically include bleach boosters, such as TAED (N,N,N′N′-tetraacetylethylenediamine), NOBS (nonanoyloxybenzene sulfonate), etc. These boosters combine with H₂O₂ to form a peracid species that is more effective than H₂O₂ alone. Although it helps the bleaching capability of detergent, the TAED reaction is only approximately 50% efficient, as only two out of the four acetyl groups in TAED are converted to peracids. Additionally, conversion of TAED into peracetic acid by hydrogen peroxide is efficient only at alkaline pHs and high temperatures. Thus, the TAED reaction is not optimized for use in all bleaching applications (e.g., those involving neutral or acidic pHs, and cold water). The present invention provides means to overcome the disadvantages of TAED use. For example, the present invention finds use in cold water applications, as well as those involving neutral or acidic pH levels. Furthermore, the present invention provides means for peracid generation from hydrogen peroxide, with a high perhydrolysis to hydrolysis ratio.

Furthermore, the perhydrolase and/or hydrolase enzymes of the present invention are active on various acyl donor substrates, as well as being active at low substrate concentrations, and provide means for efficient perhydrolysis due to the high peracid:acid ratio. Indeed, it has been recognized that higher perhydrolysis to hydrolysis ratios are preferred for bleaching applications (See e.g., U.S. Pat. Nos. 5,352,594, 5,108,457, 5,030,240, 3974,082, and 5,296,616, all of which are herein incorporated by reference). In some preferred embodiments, the perhydrolase enzymes of the present invention provide perhydrolysis to hydrolysis ratios that are greater than 1. In some particularly preferred embodiments, the perhydrolase enzymes provide a perhydrolysis to hydrolysis ratio greater than 1 and are find use in bleaching.

In addition, it has been shown to be active in commonly used detergent formulations (e.g., Ariel Futur, WOB, etc.). Thus, the present invention provides many advantages in various cleaning settings.

As indicated above, key components to peracid production by enzymatic perhydrolysis are enzyme, ester substrate, and hydrogen peroxide. Hydrogen peroxide can be either added directly in batch, or generated continuously “in situ.” Current washing powders use batch additions of H₂O₂, in the form of percarbonate or perborate salts that spontaneously decompose to H₂O₂. The perhydrolase enzymes of the present invention find use in the same washing powder batch method as the H₂O₂ source. However, these enzymes also find use with any other suitable source of H₂O₂, including that generated by chemical, electro-chemical, and/or enzymatic means. Examples of chemical sources are the percarbonates and perborates mentioned above, while an example of an electrochemical source is a fuel cell fed oxygen and hydrogen gas, and an enzymatic example includes production of H₂O₂ from the reaction of glucose with glucose oxidase. The following equation provides an example of a coupled system that finds use with the present invention.

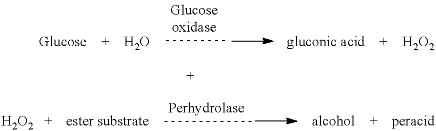

This system generates acid(s) that result in a lowering of the pH of the system. It is not intended that the present invention be limited to any specific enzyme, as any enzyme that generates H₂O₂ and acid with a suitable substrate finds use in the methods of the present invention. For example, lactate oxidases from Lactobacillus species which are known to create H₂O₂ from lactic acid and oxygen find use with the present invention. Indeed, one advantage of the methods of the present invention is that the generation of acid (e.g., gluconic acid in the above example) reduces the pH of a basic solution to the pH range in which the peracid is most effective in bleaching (i.e., at or below the pKa). Other enzymes (e.g., carbohydrate oxidase, alcohol oxidase, ethylene glycol oxidase, glycerol oxidase, amino acid oxidase, etc.) that can generate hydrogen peroxide also find use with ester substrates in combination with the perhydrolase enzymes of the present invention to generate peracids. Enzymes that generate acid from substrates without the generation of hydrogen peroxide also find use in the present invention. Examples of such enzymes include, but are not limited to esterases, lipases, phospholipases, cutinases, proteases. In some preferred embodiments, the ester substrates are selected from one or more of the following acids: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. Thus, as described herein, the present invention provides definite advantages over the currently used methods and compositions for detergent formulation and use, as well as various other applications.

### Perhydrolase Activity

The use of enzymes obtained from microorganisms is long-standing. Indeed there are numerous biocatalysts known in the art. For example, U.S. Pat. No. 5,240,835 (herein incorporated by reference) provides a description of the transacylase activity of obtained from C. oxydans and its production. In addition, U.S. Pat. No. 3,823,070 (herein incorporated by reference) provides a description of a Corynebacterium that produces certain fatty acids from an n-paraffin. U.S. Pat. No. 4,594,324 (herein incorporated by reference) provides a description of a Methylcoccus capsulatus that oxidizes alkenes. Additional biocatalysts are known in the art (See e.g., U.S. Pat. Nos. 4,008,125 and 4,415,657; both of which are herein incorporated by reference). EP 0 280 232 describes the use of a C. oxydans enzyme in a reaction between a diol and an ester of acetic acid to produce monoacetate. Additional references describe the use of a C. oxydans enzyme to make chiral hydroxycarboxylic acid from a prochiral diol. Additional details regarding the activity of the C. oxydans transacylase, as well as the culture of C. oxydans, preparation and purification of the enzyme are provided by U.S. Pat. No. 5,240,835. Thus, the transesterification capabilities of this enzyme, using mostly acetic acid esters were known. However, the determination that this enzyme could carry out perhydrolysis reaction was quite unexpected. It was even more surprising that these enzymes exhibit very high efficiencies in perhydrolysis reactions. For example, in the presence of tributyrin and water, the enzyme acts to produce butyric acid, while in the presence of tributyrin, water and hydrogen peroxide, the enzyme acts to produce mostly perbutyric acid and very little butyric acid. This high perhydrolysis to hydrolysis ratio is a unique property exhibited by the perhydrolase class of enzymes of the present invention and is a unique characteristic that is not exhibited by previously described lipases, cutinases, nor esterases.

The perhydrolase of the present invention is active over a wide pH and temperature range and accepts a wide range of substrates for acyl transfer. Acceptors include water (hydrolysis), hydrogen peroxide (perhydrolysis) and alcohols (classical acyl transfer). For perhydrolysis measurements, enzyme is incubated in a buffer of choice at a specified temperature with a substrate ester in the presence of hydrogen peroxide. Typical substrates used to measure perhydrolysis include esters such as ethyl acetate, triacetin, tributyrin, ethoxylated neodol acetate esters, and others. In addition, the wild type enzyme hydrolyzes nitrophenylesters of short chain acids. The latter are convenient substrates to measure enzyme concentration. Peracid and acetic acid can be measured by the assays described herein. Nitrophenylester hydrolysis is also described.

Although the primary example used during the development of the present invention is the M. smegmatis perhydrolase, any perhydrolase obtained from any source which converts the ester into mostly peracids in the presence of hydrogen peroxide finds use in the present invention. In some particularly preferred embodiments the perhydrolases disclosed in US04/040438 (WO 05/056782), which is incorporated by reference in its entirety.

In some preferred embodiments of the present invention, esters comprising aliphatic and/or aromatic carboxylic acids and alcohols are utilized with the perhydrolase and/or hydrolase enzymes of the present invention. In some preferred embodiments, the substrate esters are selected from one or more of the following acid esters: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. In additional embodiments, triacetin, tributyrin, neodol esters, and/or ethoxylated neodol esters serve as acyl donors for peracid/acid formation.

In some preferred embodiments of the present invention, esters comprising aliphatic and/or aromatic carboxylic acids and alcohols are utilized with the perhydrolase and/or hydrolase enzymes in the detergent formulations of the present invention. In some preferred embodiments, the substrates are selected from one or more of the following acid esters: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. Thus, in some preferred embodiments, detergents comprising at least one perhydrolase and/or hydrolase, at least one hydrogen peroxide source, and at least one acid ester are provided.

### Hydrolase Activity

In addition to the perhydrolase described herein, various hydrolases find use in the present invention, including but not limited to carboxylate ester hydrolase, thioester hydrolase, phosphate monoester hydrolase, and phosphate diester hydrolase which act on ester bonds; a thioether hydrolase which acts on ether bonds; and α-amino-acyl-peptide hydrolase, peptidyl-amino acid hydrolase, acyl-amino acid hydrolase, dipeptide hydrolase, and peptidyl-peptide hydrolase which act on peptide bonds. Such hydrolase(s) find use alone or in combination with perhydrolase. Preferable among them are carboxylate ester hydrolase, and peptidyl-peptide hydrolase. Suitable hydrolases include: (1) proteases belonging to the peptidyl-peptide hydrolase class (e.g., pepsin, pepsin B, rennin, trypsin, chymotrypsin A, chymotrypsin B, elastase, enterokinase, cathepsin C, papain, chymopapain, ficin, thrombin, fibrinolysin, renin, subtilisin, aspergillopeptidase A, collagenase, clostridiopeptidase B, kallikrein, gastrisin, cathepsin D, bromelin, keratinase, chymotrypsin C, pepsin C, aspergillopeptidase B, urokinase, carboxypeptidase A and B, and aminopeptidase); (2) carboxylate ester hydrolase including carboxyl esterase, lipase, pectin esterase, and chlorophyllase; and (3) enzymes having high perhydrolysis to hydrolysis ratios. Especially effective among them are lipases, as well as esterases that exhibit high perhydrolysis to hydrolysis ratios, as well as protein engineered esterases, cutinases, and lipases, using the primary, secondary, tertiary, and/or quaternary structural features of the perhydrolases of the present invention.

The hydrolase is incorporated into the detergent composition as much as required according to the purpose. It should preferably be incorporated in an amount of 0.00001 to 5 weight percent, and more preferably 0.02 to 3 weight percent. This enzyme should be used in the form of granules made of crude enzyme alone or in combination with other enzymes and/or components in the detergent composition. Granules of crude enzyme are used in such an amount that the purified enzyme is 0.001 to 50 weight percent in the granules. The granules are used in an amount of 0.002 to 20 and preferably 0.1 to 10 weight percent. In some embodiments, the granules are formulated so as to contain an enzyme protecting agent and a dissolution retardant material (i.e., material that regulates the dissolution of granules during use).

In use, the perhydrolase of the present invention is between about 0.01 ppm and 100 ppm in the wash liquor. In some preferred embodiments, the perhydrolase is present at a concentration of between about 0.1 and 10 ppm.

### Oxidase Activity

The detergent composition of the present invention comprise a carbohydrate oxidase, i.e. an enzyme which catalyzes the oxidation of carbohydrate substrates such as a carbohydrate monomer, di-mer, tri-mer, or oligomer and reduces molecular oxygen to generate hydrogen peroxide.

Suitable carbohydrate oxidases include carbohydrate oxidases selected from the group consisting of aldose oxidase (IUPAC classification EC1.1.3.9), galactose oxidase (IUPAC classification EC1.1.3.9), cellobiose oxidase (IUPAC classification EC1.1.3.25), pyranose oxidase (IUPAC classification EC1.1.3.10), sorbose oxidase (IUPAC classification EC1.1.3.11) and/or hexose oxidase (IUPAC classification EC1.1.3.5), glucose oxidase (IUPAC classification EC1.1.3.4) and mixtures thereof. Indeed, it is contemplated that any suitable oxidase (i.e., that follows the equation Enzyme+substrate→acid and H₂O₂) find use in the present invention.

The skilled artisan who is in possession of enzymes have classified as EC 1.1.3._, EC 1.2.3._, EC 1.4.3._, and EC 1.5.3._ will understand that similar classes of enzymes, based on the recommendations of the Nomenclature Committee of the International Union of Biochemistry and Molecular Biology (IUBMB), are useful in the present invention.

In some embodiments, preferred carbohydrate oxidases include aldose oxidase and/or galactose oxidase, more preferably is the aldose oxidase because of its broadest substrate specificity. Aldose oxidase is active on all mono-, di-, tri- and oligo-carbohydrates such as D-arabinose, L-arabinose, D-cellobiose, 2-deoxy-D-galactose, 2-deoxy-D-ribose, D-fructose, L-fucose, D-galactose, D-glucose, D-glycero-D-gulo-heptose, D-lactose, D-lyxose, L-lyxose, D-maltose, D-mannose, melezitose, L-melibiose, palatinose, D-raffinose, L-rhamnose, D-ribose, L-sorbose, stachyose, sucrose, D-trehalose, D-xylose, and L-xylose.

In some particularly preferred embodiments, a preferred carbohydrate oxidase is the aldose oxidase described in WO99/31990, being a polypeptide produced by Microdochium nivale CBS100236 or having the amino acid sequence therein described in SEQ ID NO:2 or an analogue thereof. In addition, oxidases that have significantly broader substrate specificity and therefore are capable of removing carbohydrates more efficiently and a broader spectrum of carbohydrates find use in the present invention. For example: galactose oxidase acts on D-galactose, lactose, melibiose, raffinose and stachyose; cellobiose oxidase acts on cellobiase, and also on cellodextrins, lactose, and D-mannose; pyranose oxidase acts on D-glucose, and also on D-xylose, L-sorbose, and D-glucose-1. 5-lactose; sorbose oxidase acts on L-sorbose, and also on D-glucose, D-galactose and D-xylose; and hexose oxidase acts on D-glucose, and also D-galactose, D-mannose, malton, lactose, and cellobiose.

Suitable hexose oxidases include those described in WO96/39851 (See e.g., Examples 1-6). Suitable pyranose oxidase include those described in WO97/22257 (See e.g., page 1, line 28 to page 2, line 19; page 4, line 13 to page 5 line 14; and page 10, line 35 to page 11, line 24).

In some preferred embodiments, the cleaning compositions of the present invention comprise about 0.0001% to about 10%, preferably from about 0.001% to about 0.2%, more preferably from about 0.005% to about 0.1%, pure carbohydrate oxidase enzyme by weight of the total composition.

Additional enzymes that find use in the present invention include galactose oxidase (Novozymes A/S), cellobiose oxidase (Fermco Laboratories, Inc.), galactose oxidase (Sigma), pyranose oxidase (Takara Shuzo Co.), sorbose oxidase (ICN Pharmaceuticals, Inc.), and glucose oxidase (Genencor International, Inc.).

In further embodiments, substrates including compounds such as sugar, glucose and/or galactose are added to the composition, in order to further enhance the enzymatic bleaching performance.

### Additional Cleaning Formulation Components

Additional components find use in the cleaning formulations of the present invention. Although it is not intended that the cleaning formulations of the present invention be so limited, various components are described in greater detail below. Indeed, while such components are not essential for the purposes of the present invention, the non-limiting list of adjuncts illustrated hereinafter are suitable for use in the instant cleaning compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. It is understood that such adjuncts are in addition to the enzymes of the present invention, hydrogen peroxide and/or hydrogen peroxide source and material comprising an ester moiety. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, deposition aids, dispersants, additional enzymes, and enzyme stabilizers, catalytic materials, bleach activators, bleach boosters, preformed peracids, polymeric dispersing agents, clay soil removal/anti-redeposition agents, brighteners, suds suppressors, dyes, perfumes, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282, 6,306,812, and 6,326,348, herein incorporated by reference. The aforementioned adjunct ingredients may constitute the balance of the cleaning compositions of the present invention.

Surfactants—In some embodiments, the cleaning compositions provided by the present invention comprise at least one surfactant and/or surfactant system wherein the surfactant is preferably selected from nonionic surfactants, anionic surfactants, cationic surfactants, ampholytic surfactants, zwitterionic surfactants, semi-polar nonionic surfactants, and mixtures thereof.

The surfactant is typically present at a level of from about 0.1% to about 60%, from about 1% to about 50% or even from about 5% to about 40% by weight of the subject cleaning composition.

Cationic Surfactants and Long-Chain Fatty Acid Salts—In some embodiments of the present invention such cationic surfactants and long-chain fatty acid salts, including saturated or fatty acid salts, alkyl or alkenyl ether carboxylic acid salts, a-sulfofatty acid salts or esters, amino acid-type surfactants, phosphate ester surfactants, quaternary ammonium salts including those having 3 to 4 alkyl substituents and up to 1 phenyl substituted alkyl substituents find use. Suitable cationic surfactants and long-chain fatty acid salts include those disclosed in British Patent Application No. 2 094 826 A, the disclosure of which is incorporated herein by reference. In some embodiments, the compositions comprise from about 1 to about 20 weight percent of such cationic surfactants and long-chain fatty acid salts.

Builders—In some embodiments of the present invention, the compositions comprise from about 0 to about 10 weight percent of one or more builder components selected from the group consisting of alkali metal salts and alkanolamine salts of the following compounds: phosphates, phosphonates, phosphonocarboxylates, salts of amino acids, aminopolyacetates high molecular electrolytes, non-dissociating polymers, salts of dicarboxylic acids, and aluminosilicate salts. Examples of suitable divalent sequestering agents are disclosed in British Patent Application No. 2 094 826 A, the disclosure of which is incorporated herein by reference.

In additional embodiments, compositions of the present invention contain from about 0 to about 10 weight percent, one or more alkali metal salts of the following compounds as the alkalis or inorganic electrolytes: silicates, carbonates and sulfates as well as organic alkalis such as triethanolamine, diethanolamine, monoethanolamine and triisopropanolamine. In some embodiments, the cleaning compositions of the present invention comprise one or more detergent builders and/or builder systems. When a builder is used, the subject cleaning composition typically comprises relatively low levels (e.g., from about 0% to about 10% builder by weight of the subject cleaning composition).

In various embodiments, builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—in some embodiments, the cleaning compositions provided by the present invention contain at least one chelating agent. Suitable chelating agents include copper, iron and/or manganese chelating agents and mixtures thereof.

In some preferred embodiments that include at least one chelating agent, the cleaning compositions comprise from about 0.1% to about 15%, or from about 0.5% to about 5%, of the at least one chelating agent, by weight of the subject cleaning composition.

Deposition Aids—In some further embodiments, the cleaning compositions provided by the present invention contain a deposition aid. Suitable deposition aids include, polyethylene glycol, polypropylene glycol, polycarboxylate, soil release polymers such as polytelephthalic acid, clays such as kaolinite, montmorillonite, atapulgite, illite, bentonite, halloysite, and mixtures thereof.

Anti-Redeposition Agents—In yet additional embodiments of the present invention, the compositions contain from about 0.1 to about 5 weight percent of one or more of the following compounds as anti-redeposition agents: polyethylene glycol, polyvinyl alcohol, polyvinylpyrrolidone and carboxymethylcellulose. In some preferred embodiments, a combination of carboxymethyl-cellulose and/or polyethylene glycol are utilized with the composition of the present invention as useful dirt removing compositions.

Dye Transfer Inhibiting Agents—In still further embodiments, the cleaning compositions of the present invention include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject cleaning composition, dye transfer inhibiting agents are typically present at levels from about 0.0001% to about 10%, from about 0.01% to about 5%, or from about 0.1% to about 3% by weight of the cleaning composition.

Dispersants—In additional embodiments, the cleaning compositions of the present invention contain dispersants. Suitable water-soluble organic materials include homo- or co-polymeric acids or their salts, in which the polycarboxylic acid comprises at least two carboxyl radicals separated from each other by not more than two carbon atoms.

Enzymes—In still further embodiments, the cleaning compositions provided by the present invention further comprise one or more detergent enzymes which provide cleaning performance and/or fabric care benefits. Examples of suitable enzymes include, but are not limited to, hemicellulases, peroxidases, proteases, metalloprotease, cellulases, xylanases, lipases, phospholipases, esterases, cutinases, pectinases, keratinases, reductases, oxidases, phenoloxidases, lipoxygenases, ligninases, pullulanases, tannases, pentosanases, malanases, mannanases, cellulases, β-glucanases, arabinosidases, hyaluronidase, chondroitinase, laccase, and amylases, or mixtures thereof. In some embodiments, the combination is a cocktail of conventional applicable enzymes (e.g., protease(s), lipase(s), cutinase(s), and/or cellulase(s), used in conjunction with amylase(s)).

Enzyme Stabilizers—Enzymes for use in detergents can be stabilized by various techniques. In some embodiments of the present invention, enzymes employed herein are stabilized by the presence of water-soluble sources of calcium and/or magnesium ions in the finished compositions that provide such ions to the enzymes.

Catalytic Metal Complexes—In further embodiments, the cleaning compositions of the present invention include at least one catalytic metal complex. In some embodiments, metal-containing bleach catalyst comprising a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof find use in the present invention (See e.g., U.S. Pat. No. 4,430,243, hereby incorporated by reference in its entirety).

In some embodiments, the compositions herein are catalyzed by means of a manganese compound. Such compounds and levels of use are well known in the art and include (See e.g., the manganese-based catalysts disclosed in U.S. Pat. No. 5,576,282, hereby incorporated by reference in its entirety).

Cobalt bleach catalysts also find use in the present invention. These compositions are known in the art (See e.g., U.S. Pat. No. 5,597,936 and U.S. Pat. No. 5,595,967). Such cobalt catalysts are readily prepared by known procedures (See e.g., U.S. Pat. No. 5,597,936, and U.S. Pat. No. 5,595,967).

In some embodiments, compositions of the present invention include at least one transition metal complex of a macropolycyclic rigid ligand (“MRL”). As a practical matter, and not by way of limitation, the compositions and cleaning processes herein are adjustable, so as to provide on the order of at least one part per hundred million of the active MRL species in the aqueous washing medium, and typically preferably provide from about 0.005 ppm to about 25 ppm, more preferably from about 0.05 ppm to about 10 ppm, and most preferably from about 0.1 ppm to about 5 ppm, of the MRL in the wash liquor.

In some embodiments, preferred transition-metals in the instant transition-metal bleach catalyst include manganese, iron and chromium. In some further embodiments, preferred MRLs used herein are a special type of ultra-rigid ligand that is cross-bridged such as 5,12-diethyl-1,5,8,12-tetraazabicyclo[6.6.2]hexadecane.

Suitable transition metal MRLs are readily prepared by known procedures (See e.g., WO 00/332601, and U.S. Pat. No. 6,225,464; both of which are incorporated by reference in their entirety).

Bleaching Agents—In some embodiments, the present invention provides for the use of the perhydrolases of the present invention in combination with additional bleaching agent(s) such as sodium percarbonate, sodium perborate, sodium sulfate/hydrogen peroxide adduct and sodium chloride/hydrogen peroxide adduct and/or a photo-sensitive bleaching dye such as zinc or aluminum salt of sulfonated phthalocyanine further improves the detergent effects. In additional embodiments, the perhydrolases of the present invention are used in combination with bleach boosters (e.g., TAED and/or NOBS).

Bluing Agents and Fluorescent Dyes—In some embodiments of the present invention, bluing agents and fluorescent dyes are incorporated in the composition. Examples of suitable bluing agents and fluorescent dyes are disclosed in British Patent Application No. 2 094 826 A, the disclosure of which is incorporated herein by reference.

Caking Inhibitors—In some embodiments of the present invention in which the composition is powdered or solid, caking inhibitors are incorporated in the composition. Examples of suitable caking inhibitors include p-toluenesulfonic acid salts, xylenesulfonic acid salts, acetic acid salts, sulfosuccinic acid salts, talc, finely pulverized silica, clay, calcium silicate (e.g., Micro-Cell [Johns Manville Co.]), calcium carbonate and magnesium oxide.

Antioxidants—In some additional embodiments, at least one antioxidant is included in the compositions of the present invention. In some particularly preferred embodiments, the antioxidants include, for example, tert-butyl-hydroxytoluene, 4,4′-butylidenebis(6-tert-butyl-3-methylphenol), 2,2′-butylidenebis(6-tert-butyl-4-methylphenol), monostyrenated cresol, distyrenated cresol, monostyrenated phenol, distyrenated phenol and 1,1-bis(4-hydroxy-phenyl)cyclohexane.

Solubilizers—In some embodiments, the compositions of the present invention also include solubilizers, including but not limited to lower alcohols (e.g., ethanol, benzenesulfonate salts, and lower alkylbenzenesulfonate salts such as p-toluenesulfonate salts), glycols such as propylene glycol, acetylbenzene-sulfonate salts, acetamides, pyridinedicarboxylic acid amides, benzoate salts and urea.

In some embodiments, the detergent compositions of the present invention are used in a broad pH range of from acidic to alkaline pH. In some preferred embodiments, the detergent composition of the present invention is used in mildly acidic, neutral or alkaline detergent wash media having a pH of from above about 4 to no more than about 11.

In addition to the ingredients described above, perfumes, buffers, preservatives, dyes, and the like, also find use with the present invention. These components are provided in concentrations and forms known to those in the art.

In some embodiments, the powdered detergent bases of the present invention are prepared by any known preparation methods (e.g., spray-drying methods and granulation methods). In some preferred embodiments, detergent bases obtained using the spray-drying method and/or spray-drying granulation method(s) are used. The detergent base obtained by the spray-drying method is not restricted with respect to preparation conditions. In some preferred embodiments, the spray-drying method produces hollow granules obtained by spraying an aqueous slurry of heat-resistant ingredients, such as surface active agents and builders, into a hot space. In some embodiments, after the spray-drying, perfumes, enzymes, bleaching agents, inorganic alkaline builders are added. In some embodiments utilizing highly dense, granular detergent bases obtained by such methods as spray-drying-granulation, various ingredients are also added after the preparation of the base.

In some embodiments utilizing liquid detergent bases, the base is a homogenous solution, while in other embodiments, it is an non-homogenous dispersion.

In some embodiments, the detergent compositions of the present invention are incubated with fabric (e.g., soiled fabrics), in industrial and household uses at temperatures, reaction times and liquor ratios conventionally employed in these environments. The incubation conditions (i.e., the conditions effective for treating materials with detergent compositions according to the present invention), are readily ascertainable by those of skill in the art. Accordingly, the appropriate conditions effective for treatment with the present detergents correspond to those using similar detergent compositions which include wild-type perhydrolase.

As indicated above, in some embodiments, detergents provided by the present invention are formulated as a pre-wash in the appropriate solution at an intermediate pH, where sufficient activity exists to provide desired improvements, such as softening, depilling, pilling prevention, surface fiber removal and/or cleaning. When the detergent composition is a pre-soak (e.g., pre-wash or pre-treatment) composition, either as a liquid, spray, gel or paste composition, the perhydrolase enzyme is generally employed from about 0.00001% to about 5% weight percent, based on the total weight of the pre-soak or pre-treatment composition. In some embodiments of such compositions, at least one surfactant is optionally employed. When used, such surfactants are generally present at a concentration of from about 0.0005 to about 1 weight percent, based on the total weight of the pre-soak. The remainder of the composition comprises conventional components used in the pre-soak (e.g., diluent, buffers, other enzymes (e.g., proteases), etc.) at their conventional concentrations.

### Cleaning Compositions

The cleaning compositions of the present invention find use in various applications, including laundry applications, hard surface cleaning, automatic dishwashing applications, as well as in cosmetic applications such as cleaning of dentures, teeth, hair, and/or skin. However, due to the unique advantages of increased effectiveness in lower temperature solutions and the superior color-safety profile, the enzymes of the present invention are ideally suited for laundry applications such as the bleaching of fabrics. Furthermore, the enzymes of the present invention find use in both granular and liquid compositions.

The enzymes of the present invention also find use in cleaning additive products. Cleaning additive products including the enzymes of the present invention are ideally suited for inclusion in wash processes where additional bleaching effectiveness is desired. Such instances include, but are not limited, to low temperature solution cleaning applications. In some embodiments, the additive product is, in its simplest form, one or more of the enzymes of the present invention. In some embodiments, the additive(s) are packaged in dosage form suitable for addition to a cleaning process where a source of peroxygen is employed and increased bleaching effectiveness is desired. In some embodiments, the single dosage form is a pill, while in other embodiments, it is a tablet, gelcap, or other single dosage unit, such as pre-measured powders or liquids. In some preferred embodiments, at least one filler or carrier material is included, in order to increase the volume of such composition. Suitable filler or carrier materials include, but are not limited to, various salts of sulfate, carbonate and silicate as well as talc, clay and the like. In some embodiments, filler or carrier materials for liquid compositions comprise water or low molecular weight primary and secondary alcohols including polyols and diols. Examples of such alcohols include, but are not limited to, methanol, ethanol, propanol and isopropanol. In some embodiments, the compositions comprise from about 5% to about 90% of such materials. In some embodiments, acidic fillers find use in reducing pH. In some alternative embodiments, the cleaning additive includes at least one activated peroxygen source and/or or adjunct ingredients as described herein.

The cleaning compositions and cleaning additives of the present invention require an effective amount of the enzymes provided by the present invention. In some particularly preferred embodiments, the required level of enzyme is achieved by the addition of one or more species of the M. smegmatis perhydrolase, variants, homologues, and/or other enzymes or enzyme fragments having the activity of the enzymes of the present invention. Typically, the cleaning compositions of the present invention comprise at least 0.0001 weight percent, from about 0.0001 to about 1, from about 0.001 to about 0.5, or even from about 0.01 to about 0.1 weight percent of at least one enzyme of the present invention.

In some embodiments, the cleaning compositions of the present invention comprise a material selected from the group consisting of a peroxygen source, hydrogen peroxide and mixtures thereof, the peroxygen source being selected from the group consisting of:

(i) from about 0.01 to about 50, from about 0.1 to about 20, or even from about 1 to 10 weight percent of a per-salt, an organic peroxyacid, urea hydrogen peroxide and mixtures thereof;

(ii) from about 0.01 to about 50, from about 0.1 to about 20, or even from about 1 to 10 weight percent of a carbohydrate and from about 0.0001 to about 1, from about 0.001 to about 0.5, from about 0.01 to about 0.1 weight percent carbohydrate oxidase; and

(iii) mixtures thereof.

Suitable per-salts include those selected from the group consisting of alkalimetal perborate, alkalimetal percarbonate, alkalimetal perphosphates, alkalimetal persulphates and mixtures thereof.

In some preferred embodiments, the carbohydrate(s) is/are selected from the group consisting of mono-carbohydrates, di-carbohydrates, tri-carbohydrates, oligo-carbohydrates and mixtures thereof. Suitable carbohydrates include carbohydrates selected from the group consisting of D-arabinose, L-arabinose, D-cellobiose, 2-deoxy-D-galactose, 2-deoxy-D-ribose, D-fructose, L-fucose, D-galactose, D-glucose, D-glycero-D-gulo-heptose, D-lactose, D-lyxose, L-lyxose, D-maltose, D-mannose, melezitose, L-melibiose, palatinose, D-raffinose, L-rhamnose, D-ribose, L-sorbose, stachyose, sucrose, D-trehalose, D-xylose, L-xylose and mixtures thereof.

Suitable carbohydrate oxidases include carbohydrate oxidases selected from the group consisting of aldose oxidase (IUPAC classification EC1.1.3.9), galactose oxidase (IUPAC classification EC1.1.3.9), cellobiose oxidase (IUPAC classification EC1.1.3.25), pyranose oxidase (IUPAC classification EC1.1.3.10), sorbose oxidase (IUPAC classification EC1.1.3.11) and/or hexose oxidase (IUPAC classification EC1.1.3.5), Glucose oxidase (IUPAC classification EC1.1.3.4) and mixtures thereof.

In some preferred embodiments, the cleaning compositions of the present invention also include from about 0.01 to about 99.9, from about 0.01 to about 50, from about 0.1 to 20, or even from about 1 to about 15 weight percent a molecule comprising an ester moiety. Suitable molecules comprising an ester moiety may have the formula:

R¹Oₓ[(R²)ₘ(R³)ₙ]ₚ

wherein R¹ is a moiety selected from the group consisting of H or a substituted or unsubstituted alkyl, heteroalkyl, alkenyl, alkynyl, aryl, alkylaryl, alkylheteroaryl, and heteroaryl; in one aspect of the present invention, R¹ may comprise from 1 to 50,000 carbon atoms, from 1 to 10,000 carbon atoms, or even from 2 to 100 carbon atoms;

each R² is an alkoxylate moiety, in one aspect of the present invention, each R² is independently an ethoxylate, propoxylate or butoxylate moiety;

R³ is an ester-forming moiety, with some embodiments having the formula:
R⁴CO— wherein R⁴ is H, substituted or unsubstituted alkyl, alkenyl, alkynyl, aryl, alkylaryl, alkylheteroaryl, and heteroaryl, in one aspect of the present invention, R⁴ is substituted or unsubstituted alkyl, alkenyl, alkynyl, moiety comprising from 1 to 22 carbon atoms, an aryl, alkylaryl, alkylheteroaryl, or heteroaryl moiety comprising from 4 to 22 carbon atoms or R⁴ is substituted or unsubstituted C₁-C₂₂ alkyl moiety or R⁴ is be a substituted or unsubstituted C₁-C₁₂ alkyl moiety;
x is 1 when R¹ is H; when R¹ is not H, x is an integer that is equal to or less than the number of carbons in R¹
p is an integer that is equal to or less than x
m is an integer from 0 to 50, an integer from 0 to 18, or an integer from 0 to 12, and n is at least 1.

In one aspect of the present invention, the molecule comprising an ester moiety is an alkyl ethoxylate or propoxylate having the formula R¹Oₓ[(R²)ₘ(R³)ₙ]ₚ wherein:
R¹ is an C₂-C₃₂ substituted or unsubstituted alkyl or heteroalkyl moiety;
each R² is independently an ethoxylate or propoxylate moiety;
R³ is an ester-forming moiety having the formula:
R⁴CO— wherein R⁴ is H, substituted or unsubstituted alkyl, alkenyl, alkynyl, aryl, alkylaryl, alkylheteroaryl, and heteroaryl, in one aspect of the present invention, R⁴ is a substituted or unsubstituted alkyl, alkenyl, or alkynyl moiety comprising from 1 to 22 carbon atoms, a substituted or unsubstituted aryl, alkylaryl, alkylheteroaryl, or heteroaryl moiety comprising from 4 to 22 carbon atoms or R⁴ is a substituted or unsubstituted C₁-C₂₂ alkyl moiety or R⁴ is a substituted or unsubstituted C₁-C₁₂ alkyl moiety;
x is an integer that is equal to or less than the number of carbons in R¹
p is an integer that is equal to or less than x
m is an integer from 1 to 12, and
n is at least 1.

In one aspect of the present invention, the molecule comprising the ester moiety has the formula:

R¹Oₓ[(R²)ₘ(R³)ₙ]ₚ

wherein R¹ is H or a moiety that comprises a primary, secondary, tertiary or quaternary amine moiety, the R¹ moiety that comprises an amine moiety being selected from the group consisting of a substituted or unsubstituted alkyl, heteroalkyl, alkenyl, alkynyl, aryl, alkylaryl, alkylheteroaryl, and heteroaryl; in one aspect of Applicants' invention R¹ comprises from 1 to 50,000 carbon atoms, from 1 to 10,000 carbon atoms, or even from 2 to 100 carbon atoms;

each R² is an alkoxylate moiety, in one aspect of the present invention each R² is independently an ethoxylate, propoxylate or butoxylate moiety;
R³ is an ester-forming moiety having the formula:
   R⁴CO— wherein R⁴ may be H, substituted or unsubstituted alkyl, alkenyl, alkynyl, aryl, alkylaryl, alkylheteroaryl, and heteroaryl, in one aspect of the present invention, R⁴ may be a substituted or unsubstituted alkyl, alkenyl, or alkynyl moiety comprising from 1 to 22 carbon atoms, a substituted or unsubstituted aryl, alkylaryl, alkylheteroaryl, or heteroaryl moiety comprising from 4 to 22 carbon atoms or R⁴ may be a substituted or unsubstituted C₁-C₂₂ alkyl moiety or R⁴ may be a substituted or unsubstituted C₁-C₁₂ alkyl moiety;
x is 1 when R¹ is H; when R¹ is not H, x is an integer that is equal to or less than the number of carbons in R¹
p is an integer that is equal to or less than x
m is an integer from 0 to 12 or even 1 to 12, and
n is at least 1.

In some embodiments of any of the aforementioned aspects of the present invention, the molecule comprising an ester moiety has a weight average molecular weight of less than about 600,000 Daltons, less than about 300,000 Daltons, less than about 100,000 Daltons or even less than about 60,000 Daltons.

Suitable molecules that comprise an ester moiety include polycarbohydrates that comprise an ester moiety.

The cleaning compositions provided herein are typically formulated such that, during use in aqueous cleaning operations, the wash water has a pH of from about 5.0 to about 11.5, or even from about 7.5 to about 10.5. Liquid product formulations are typically formulated to have a pH from about 3.0 and about 9.0. Granular laundry products are typically formulated to have a pH from about 9 to about 11. Techniques for controlling pH at recommended usage levels include the use of buffers, alkalis, acids, etc., and are well known to those skilled in the art.

In some embodiments, when the enzyme(s) of the present invention is/are employed in a granular composition or liquid, it is desirable for the enzyme(s) to be in the form of an encapsulated particle to protect such enzyme from other components of the granular or liquid composition during storage. In addition, encapsulation provides a means of controlling the availability of the enzyme(s) during the cleaning process. In some embodiments, encapsulation enhances performance of the enzyme(s). In this regard, the enzyme(s) are encapsulated with any suitable encapsulating material known in the art.

The encapsulating material typically encapsulates at least part of the enzyme(s). Typically, the encapsulating material is water-soluble and/or water-dispersible. In some embodiments, the encapsulating material has a glass transition temperature (Tg) of 0° C. or higher (See e.g., WO 97/11151, especially from page 6, line 25, to page 7, line 2, for more detail on glass transition temperatures).

In some embodiments, the encapsulating material is selected from the group consisting of carbohydrates, natural gums, synthetic gums, chitin, chitosan, cellulose, cellulose derivatives, silicates, phosphates, borates, polyvinyl alcohol, polyethylene glycol, paraffin waxes, and combinations thereof. When the encapsulating material is a carbohydrate, it is typically selected from the group consisting of monosaccharides, oligosaccharides, polysaccharides, and combinations thereof. In some preferred embodiments, the encapsulating material is a starch (See e.g., EP 0 922 499, U.S. Pat. No. 4,977,252, U.S. Pat. No. 5,354,559, and U.S. Pat. No. 5,935,826, for descriptions of some suitable starches).

In some alternative embodiments, the encapsulating material is a microsphere made from plastic material(s), including but not limited to thermoplastics, acrylonitriles, methacrylonitrile, polyacrylonitrile, polymethacrylonitrile and mixtures thereof. Suitable commercially available microspheres include EXPANCEL® (Expancel, Stockviksverken, Sweden), PM 6545, PM 6550, PM 7220, PM 7228, EXTENDOSPHERES®, LUXSIL®, Q-CEL® and SPHERICEL® (PQ Corp., Valley Forge, Pa.).

### Processes of Making and Using the Cleaning Compositions of the Present Invention

The cleaning compositions of the present invention are formulated into any suitable form and prepared by any process chosen by the formulator (See e.g., U.S. Pat. Nos. 5,879,584; 5,691,297; 5,574,005; 5,569,645; 5,565,422; 5,516,448; 5,489,392; and 5,486,303; all of which are incorporated herein by reference, for non-limiting examples).

### Method of Use

The cleaning compositions disclosed herein of find use in cleaning fabrics and/or surfaces. Typically at least a portion of the site to be cleaned is contacted with an embodiment of the present cleaning composition, in neat form or diluted in wash liquor, and then the site is optionally washed and/or rinsed. For purposes of the present invention, washing includes but is not limited to, scrubbing, and mechanical agitation. The fabric comprises any suitable fabric capable of being laundered in normal consumer use conditions. The cleaning compositions of the present invention are typically employed at concentrations of from about 500 ppm to about 15,000 ppm in solution. When the wash solvent is water, the water temperature typically ranges from about 5° C. to about 90° C. In embodiments in which fabric is cleaned, the water to fabric mass ratio is typically from about 1:1 to about 30:1.

### EXPERIMENTAL

The following examples are provided in order to demonstrate and further illustrate certain preferred embodiments and aspects of the present invention and are not to be construed as limiting the scope thereof.

In the experimental disclosure which follows, the following abbreviations apply: ° C. (degrees Centigrade); rpm (revolutions per minute); H₂O (water); HCl (hydrochloric acid); aa (amino acid); bp (base pair); kb (kilobase pair); kD (kilodaltons); gm (grams); μg and ug (micrograms); mg (milligrams); ng (nanograms); μl and ul (microliters); ml (milliliters); mm (millimeters); nm (nanometers); μm and um (micrometer); M (molar); mM (millimolar); μM and uM (micromolar); U (units); V (volts); MW (molecular weight); sec (seconds); min(s) (minute/minutes); hr(s) (hour/hours); MgCl₂ (magnesium chloride); NaCl (sodium chloride); OD₂₈₀ (optical density at 280 nm); OD₆₀₀ (optical density at 600 nm); PAGE (polyacrylamide gel electrophoresis); GC (gas chromatography); EtOH (ethanol); PBS (phosphate buffered saline [150 mM NaCl, 10 mM sodium phosphate buffer, pH 7.2]); SDS (sodium dodecyl sulfate); Tris (tris(hydroxymethyl)aminomethane); TAED (N,N,N′N′-tetraacetylethylenediamine); w/v (weight to volume); v/v (volume to volume); Per (perhydrolase); per (perhydrolase gene); Ms (M. smegmatis); MS (mass spectroscopy); BRAIN (BRAIN Biotechnology Research and Information Network, AG, Zwingenberg, Germany); TIGR (The Institute for Genomic Research, Rockville, Md.); AATCC (American Association of Textile and Coloring Chemists); WFK (wfk Testgewebe GmbH, Bruggen-Bracht, Germany); Amersham (Amersham Life Science, Inc. Arlington Heights, Ill.); ICN (ICN Pharmaceuticals, Inc., Costa Mesa, Calif.); Pierce (Pierce Biotechnology, Rockford, Ill.); Amicon (Amicon, Inc., Beverly, Mass.); ATCC (American Type Culture Collection, Manassas, Va.); Amersham (Amersham Biosciences, Inc., Piscataway, N.J.); Becton Dickinson (Becton Dickinson Labware, Lincoln Park, N.J.); BioRad (BioRad, Richmond, Calif.); Clontech (CLONTECH Laboratories, Palo Alto, Calif.); Difco (Difco Laboratories, Detroit, Mich.); GIBCO BRL or Gibco BRL (Life Technologies, Inc., Gaithersburg, Md.); Novagen (Novagen, Inc., Madison, Wis.); Qiagen (Qiagen, Inc., Valencia, Calif.); Invitrogen (Invitrogen Corp., Carlsbad, Calif.); Genaissance (Genaissance Pharmaceuticals, Inc., New Haven, Conn.); DNA 2.0 (DNA 2.0, Menlo Park, Calif.); MIDI (MIDI Labs, Newark, Del.) InvivoGen (InvivoGen, San Diego, Calif.); Sigma (Sigma Chemical Co., St. Louis, Mo.); Sorvall (Sorvall Instruments, a subsidiary of DuPont Co., Biotechnology Systems, Wilmington, Del.); Stratagene (Stratagene Cloning Systems, La Jolla, Calif.); Roche (Hoffmann La Roche, Inc., Nutley, N.J.); Agilent (Agilent Technologies, Palo Alto, Calif.); Minolta (Konica Minolta, Ramsey, N.J.); Zeiss (Carl Zeiss, Inc., Thornwood, N.Y.); Genencor (Genencor International, Inc., Palo Alto, Calif.); Expancel (Expancel, Stockviksverken, Sweden); PQ Corp. (PQ Corp., Valley Forge, Pa.); BASF (BASF Aktiengesellschaft, Florham Park, N.J.); Monsanto (Monsanto, Co., St. Louis, Mo.); Novozymes (Novozymes A/S, Bagsvaerd, Denmark); Wintershall (Winterschall AG., Kassel, Germany); Gist-Brocades (Gist-Brocades, Nev., Ma Delfit, The Netherlands); Enichem (EniChem Americas, Inc., Houston, Tex.); Huntsman (Huntsman Corp., Salt Lake City, Utah); Fluka (Fluka Chemie AG, Buchs, Switzerland); and Dow Corning (Dow Corning, Corp., Midland, Mich.).

Additional abbreviations applicable to detergent formulations are provided in the following Table:

LAS: Sodium linear C₁₁₋₁₃ alkyl benzene sulfonate
TAS: Sodium tallow alkyl sulfate
CxyAS: Sodium C₁ₓ-C_{1y} alkyl sulfate
CxyEz: C₁ₓ-C_{1y} predominantly linear primary alcohol condensed with an average of z moles of ethylene oxide
CxyAEzS: C₁ₓ-C_{1y} sodium alkyl sulfate condensed with an average of z moles of ethylene oxide (added molecule names are in the Examples).
Nonionic: Mixed ethoxylated/propoxylated fatty alcohol (e.g., Plurafac LF404) particularly alcohols with an average degree of ethoxylation of 3.8 and an average degree of propoxylation of 4.5
QAS: R₂.N+(CH₃)₂(C₂H₄OH) with R₂═C₁₂-C₁₄
Silicate: Amorphous sodium silicate (SiO₂:Na₂O ratio=1.6−3.2:1)
Metasilicate: Sodium metasilicate (SiO₂:Na₂O ratio=1.0)
Zeolite A: Hydrated aluminosilicate of formula Na₁₂(AlO₂SIO₂)₁₂. 27H₂O
SKS-6: Crystalline layered silicate of formula δ-Na₂Si₂O₅
Sulphate: Anhydrous sodium sulphate
STPP: Sodium tripolyphosphate
MA/AA: Random copolymer of 4:1 acrylate/maleate, average molecular weight about 70,000-80,000
AA: Sodium polyacrylate polymer of average molecular weight 4,500
Polycarboxylate: Copolymer comprising mixture of carboxylated monomers such as acrylate, maleate and methyacrylate with a MW ranging between 2,000-80,000 (e.g., Sokolan™ a copolymer of acrylic acid, MW4,500; BASF)
BB1: 3-(3,4-Dihydroisoquinolinium)propane sulfonate
BB2 1-(3,4-dihydroisoquinolinium)-decane-2-sulfate
PB1: Sodium perborate monohydrate
PB4: Sodium perborate tetrahydrate of nominal formula NaBO₃.4H₂O
Percarbonate: Sodium percarbonate of nominal formula 2Na₂CO₃.3H₂O₂
TAED: Tetraacetyl ethylene diamine
NOBS: Nonanoyloxybenzene sulfonate in the form of the sodium salt
DTPA: Diethylene triamine pentaacetic acid
HEDP: 1,1-hydroxyethane diphosphonic acid
DETPMP: Diethyltriamine penta(methylene)phosphonate (e.g., Dequest 2060™; Monsanto)
EDDS: Ethylenediamine-N,N′-disuccinic acid, (S,S) isomer in the form of its sodium salt
Diamine: Dimethyl aminopropyl amine; 1,6-hezane diamine; 1,3-propane diamine; 2-methyl-1,5-pentane diamine; 1,3-pentanediamine; 1-methyl-diaminopropane
DETBCHD 5,12-diethyl-1,5,8,12-tetraazabicyclo[6,6,2]hexadecane, dichloride, Mn(II) salt
PAAC: Pentaamine acetate cobalt(III) salt

### Paraffin: Paraffin oil (e.g., Winog 70™; Wintershall)

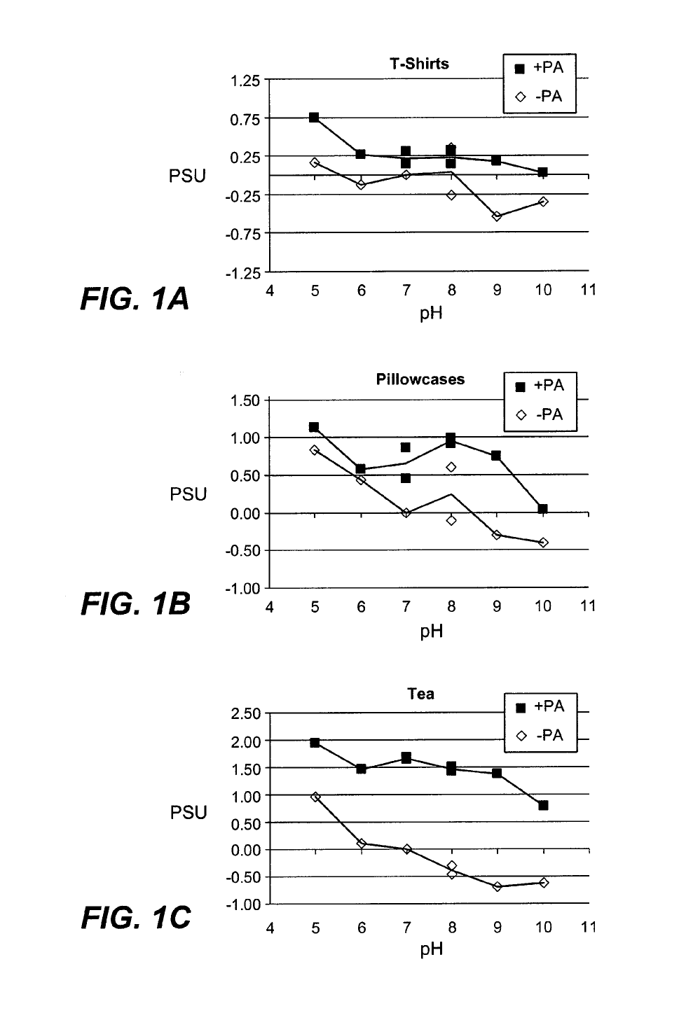

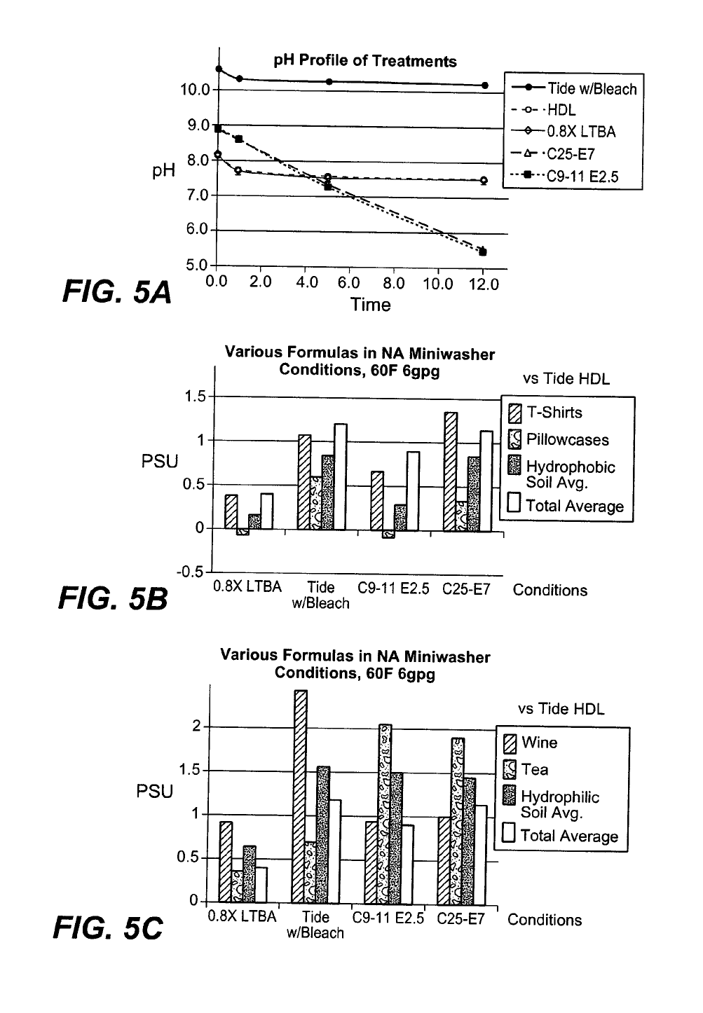

Paraffin Sulfonate: A Paraffin oil or wax in which some of the hydrogen atoms have been replaced by sulfonate groups
Aldose oxidase: Oxidase enzyme (e.g., aldose oxidase; Novozymes)
Galactose oxidase: Galactose oxidase (e.g., from Sigma)
Protease: Proteolytic enzymes (e.g., SAVINASE, ALCALASE®, EVERLASE®; Novozymes; and “Protease A” described in US RE 34,606 in FIGS. 1A, 1B, and 7, and at column 11, lines 11-37; “Protease B” described in U.S. Pat. No. 5,955,340 and U.S. Pat. No. 5,700,676 in FIGS. 1A, 1B and 5, as well as Table 1; and “Protease C” described in U.S. Pat. No. 6,312,936 and U.S. Pat. No. 6,482,628 in FIGS. 1-3 [SEQ ID 3], and at column 25, line 12, “Protease D” being the variant 101G/103A/104I/159D/232V/236H/245R/248D/252K (BPN′ numbering) described in WO 99/20723, and ASP described in US04/039006; Genencor)
Amylase: Amylolytic enzymes (e.g., PURAFECT® Ox Am; described in WO 94/18314, and WO 96/05295 to Genencor; and NATALASE®, TERMAMYL®, FUNGAMYL® and DURAMYL®; Novozymes)
Lipase: Lipolytic enzymes (e.g., LIPOLASE®, LIPOLASE® Ultra; Novozymes; and Lipomax™; Gist-Brocades)
Cellulase: Cellulytic enzymes (e.g., CAREZYME®, CELLUZYME®, ENDOLASE®; Novozymes)

### Pectin Lyase: PECTAWAY® and PECTAWASH® (Novozymes).

PVP: Polyvinylpyrrolidone with an average molecular weight of 60,000
PVNO: Polyvinylpyridine-N-Oxide, with an average molecular weight of 50,000
PVPVI: Copolymer of vinylimidazole and vinylpyrrolidone, with an average molecular weight of 20,000
Brightener 1: Disodium 4,4′-bis(2-sulphostyryl)biphenyl
Silicone antifoam: Polydimethylsiloxane foam controller with siloxane-oxyalkylene copolymer as dispersing agent with a ratio of the foam controller to the dispersing agent of 10:1 to 100:1
Suds Suppressor: 12% Silicone/silica, 18% stearyl alcohol, 70% starch in granular form
SRP 1: Anionically end capped poly esters
PEG X: Polyethylene glycol, of a molecular weight of “X”
PVP K60®: Vinylpyrrolidone homopolymer (average MW 160,000)
Jeffamine® ED-2001: Capped polyethylene glycol (e.g., from Huntsman)
Isachem® AS: A branched alcohol alkyl sulphate (e.g., from Enichem)
MME PEG (2000): Monomethyl ether polyethylene glycol (MW 2000) (e.g., from Fluka).
DC3225C: Silicone suds suppresser, mixture of silicone oil and silica (e.g., from Dow Corning).
TEPAE: Tetreaethylenepentaamine ethoxylate

### BTA: Benzotriazole

### Betaine: (CH₃)₃N⁺CH₂COO⁻

Sugar: Industry grade D-glucose or food grade sugar
CFAA: C₁₂-C₁₄ alkyl N-methyl glucamide
TPKFA: C₁₂-C₁₄ topped whole cut fatty acids
Clay: A hydrated aluminumu silicate in a general formula Al₂O₃SiO₂. xH₂O (e.g., kaolinite, montmorillonite, atapulgite, illite, bentonite, halloysite).
MCAEM: Esters in the formula of R¹Oₓ[(R²)ₘ(R³)ₙ]ₚ
Formula pH: Measured as a 1% solution in distilled water at 20° C.
Perhydrolase: Enzyme described in US04/040438 including wild-type (WT) and variants (e.g. S54V).
ZPB: Hexamethylenediamine E24 dimethyl quat, tetrasulfates

In some of the following experiments, a spectrophotometer was used to measure the absorbance of the products formed after the completion of the reactions. A reflectometer was used to measure the reflectance of the swatches. Unless otherwise indicated, protein concentrations were estimated by Coomassie Plus (Pierce), using BSA as the standard.

### Example 1

### Enzyme Analysis

In this Example, methods to assess enzyme purity and activity used in the subsequent Examples and throughout the present Specification are described.

### Enzyme Activity Assay (pNB Assay)

This activity was measured by hydrolysis of p-nitrophenylbutyrate. The reaction mixture was prepared by adding 10 ul of 100 mM p-nitrophenylbutyrate in dimethylsulfoxide to 990 ml of 100 mM Tris-HCl buffer, pH 8.0 containing 0.1% triton X-100. The background rate of hydrolysis was measured before the addition of enzyme at 410 nm. The reaction was initiated by the addition of 10 ul of enzyme to 990 ml of the reaction and the change of absorbance at 410 nm was measured at room temperate (˜23° C.). The background corrected results are reported as δA₄₁₀/min/ml or δA₄₁₀/min/mg protein.

Enzyme components weights provided herein are based on total active protein. All percentages and ratios were calculated by weight unless otherwise indicated. All percentages and ratios were calculated based on the total composition unless otherwise indicated.

### Example 2

### Effect of pH on Peracetic Acid Cleaning Performance

In this Example, experiments conducted to determine the effect of pH on peracetic acid cleaning performance are described.
A. Method for Testing Detergent Performance in Small-Scale Stains:

Stains for testing were obtained from commercial providers (i.e., Testfabrics). Target test stains were consumer dingy T-shirts, consumer dingy pillowcases, prepared tea stains (Testfabrics, Tea for Low Temp on Cotton, STC CFT BC-3), and prepared wine stains (Testfabrics, Cotton Soiled with Wine, STC CFT CS-3). Consumer dingy articles were used as ballast to complete a wash load of 0.6 pounds per 2 gallons. Consumer items were collected and prepared from soiled clothing donated by regional residents. Areas of confluent staining were identified and cut into approximately 4-inch by 4-inch swatches from the target dingy consumer test stains. These swatches were then cut in half and labeled for use in comparing two wash treatments.

### Small-Scale Laundry Protocol:

### Preparation:

Typically, small-scale wash experiments compared five different treatments from three treatment replicates, with two replicates of each target stain per treatment. Therefore, two of each prepared stain were used in each treatment. Consumer test stains were prepared so that each treatment contained half of a swatch paired to each of the other treatments. Therefore, a five-treatment test contained 10 pairs of consumer test stains, where each treatment contained 4 stain halves, to provide pair-wise comparisons. This pair-wise arrangement of consumer test stains was done in duplicate for all treatments. Stains were combined and weighed for each treatment, and consumer dingy ballast was added for a final wash load of 0.6 pounds. Treatment compositions were weighed or aliquoted depending upon component form. A 3:1 calcium to magnesium, 10,000 grains per gallon (gpg) water hardness solution was prepared by dissolving 188.57 g calcium chloride dihydrate and 86.92 g magnesium chloride hexahydrate in purified water to 1 L.

Wash Procedure:
1. Five small-scale top loading washer tubs were filled with 2 gallons (7.75 L) deionized water at 60° F.
2. Water hardness was tested and adjusted to 6 gpg by adding water hardness solution.
3. Treatment components were added to their respective tubs and agitation at 75 rpm was started.
4. pH was measured and adjusted with 1N NaOH or HCl as desired.
5. Agitation was stopped, stains and ballast were added, and then agitation was immediately restarted.
6. Stains and articles were washed for 12 minutes. pH was monitored throughout the wash.
7. Drain and spin at a medium washing machine speed for 2 minutes.
8. Fill tubs again with 2 gallons deionized water at 60° F. and adjust water hardness.
9. Agitate for 2 minutes.
10. Drain and spin again at a medium washing machine speed for 2 minutes.
11. Remove stains and ballast from pots.
12. Combine all stains and dry in dryer at medium heat on a permanent press cycle for 45 minutes.
13. Dry ballast in dryer on high heat for 45 minutes and dispose.
14. Iron stains with medium heat and arrange for grading.

Grading of Stains:

The PSU grading systems was used to compare products, as described in greater detail below. The formulae were tested on performance (e.g., post-wash stain residual). In these experiments, several fabrics were washed with the fomulae to be compared. Stains were visually graded by three separate graders, who assigned panel score units (PSU) using the 0-4 Sheffe scale:
0. No preference
1. I think this product is a little better (unsure)
2. I know this product is a little better
3. This product is better
4. This product is much better

Prepared stains (e.g., tea and wine), were graded in a round robin, where the stains from the same cycle replicate for all treatments were compared with each other. Consumer test stains (e.g., dingy T-shirts and pillowcases), were graded pair-wise, where the stained swatches that were halved for two different treatments were compared. A treatment mean for each stain type for each treatment was then calculated by compiling the comparisons of all swatches for all treatments.
B. Effect of pH on Peracid Cleaning Performance

The method for testing detergent performance on a small-scale was used to test the effect of pH on peracetic acid cleaning of consumer dingy T-shirts and pillowcases, and prepared tea stains. Two sets of eight treatment three replicate experiments were conducted to compare the pH range of 5 to 10 with and without peracetic acid. Low ionic strength buffers were used, and buffers that chelate metal ions were avoided.

Composition (in 2 Gallon Wash):

| | |
|---|---|
| 300 ppm C₁₂-C₁₃E6.5 | 2.25 ml C₁₂-C₁₃E6.5 acetate |
| acetate +/− 0.5 mM | 1 ml 3.78 M peracetic acid (+4M acetic |
| peracetic acid | acid stock) |
| | 1 ml 7.5 M acetic acid (for nil peracetic |
| | acid) |
| 5 mM buffer | 38 ml 1M (acetate pH 5-6, bicarbonate pH |
| Borate | 7.5-8.5, pH 9.25-10.5) |
| 6 gpg water hardness | up to 4.5 ml of 10,000 gpg 3:1 Ca:Mg |
| | (water hardness stock) |
| NaOH to adjust pH | 7.75 ml 1N NaOH (to adjust peracid addition) |

Performance:

FIG. 1 shows the effect of peracetic acid on cleaning of consumer dingy soils and prepared tea stains. As shown in this Figure, the overall cleaning of all soils generally increased as the pH decreased, both with and without peracetic acid. The greatest added benefit of peracetic acid on cleaning was observed to occur at pHs 8 and 9, where the difference in cleaning between the conditions with and without peracetic acid was greatest. This pH corresponds to the pKa of peracetic acid of 8.2. The cleaning benefit of low pH and the peracetic acid bleaching optimum of pH 8-9 indicate that a detergent composition that covers a wide pH range provides improved cleaning performance.

### Example 3

### Determination of Parameters for Generating a Dynamic pH in Wash

In this Example, experiments conducted to determine the parameters involved in dynamic pH wash conditions are described. Generating a dynamic pH in the wash requires an understanding of titratable materials in the wash. While components can be designed to provide a dynamic pH, soiled clothing and median city water have inherent buffering capacities that are much harder to control. Nonetheless, experiments were conducted to make these determinations.
A. Titration of Dingy Ballast for Dynamic pH

The 2 gallon small-scale top loading tubs were filled with 2 gallons of deionized water and water hardness was adjusted to 6 gpg using the water hardness solution from Example 2, A. Components were added to wash concentrations of 100 ppm of LAS, 20 ppm of citrate, and 200 ppm of triacetin. Variable amounts of PB1, and 1 ppm of perhydrolase were added at various times in order to achieve different pH profiles in the wash. Agitation was started at 75 rpm and 0.6 pounds of consumer dingy articles were then added. Agitation continued for 20 minutes and the pH was monitored throughout.

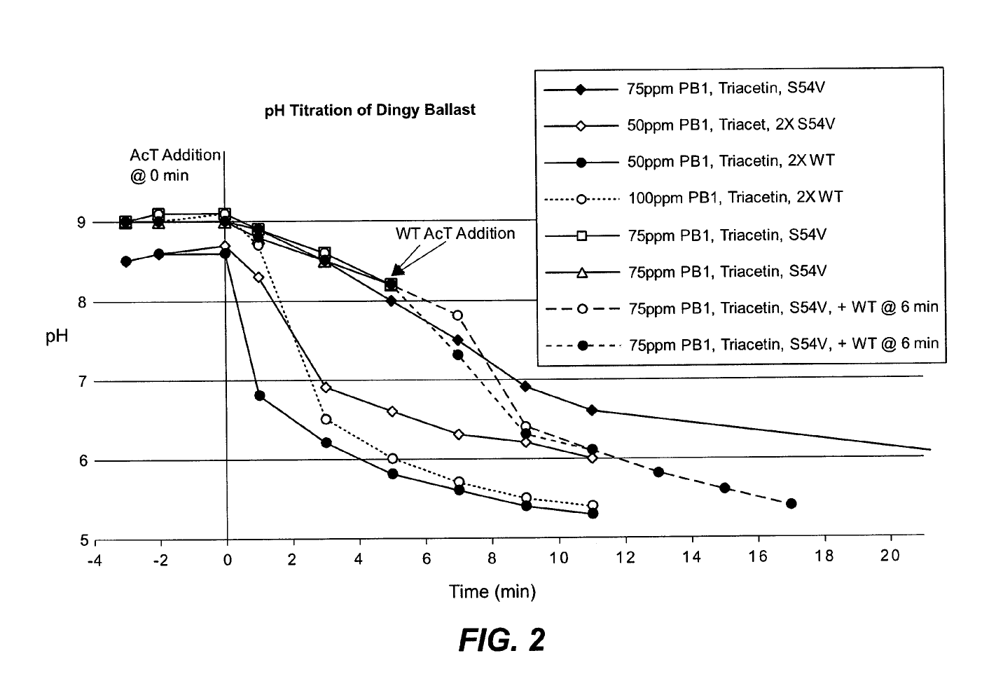

FIG. 2 shows the various pH profiles associated with adding various amounts of perborate, various perhydrolases, and at different times. The desired pH profile was achieved with 75 ppm of PB1 and 1 ppm of a high efficiency perhydrolase (S54V) with a delayed addition at 5 minutes of a low efficiency perhydrolase with high hydrolysis activity (WT). The pH profile dropped slightly from 9 to 8 in the first 6 minutes, while the first enzyme was producing peracetic acid. After 6 minutes, the pH dropped drastically with the addition of the enzyme with high hydrolysis activity.
B. Substrate and Enzyme Parameters Generating a Dynamic pH Performance Benefit

The method set forth in Example 2, part A for testing detergent performance in small-scale was used to test substrate and enzyme parameters generating a dynamic pH on cleaning performance. Cleaning was assessed on consumer dingy T-shirts and pillowcases, and prepared tea and wine stains. A five treatment, three replicate experiment was conducted, in which additions of a high efficiency perhydrolase (S54V) and a low efficiency high hydrolysis activity perhydrolase (WT) were added at various times throughout the wash cycle. The treatments were compared to and normalized against commercial TIDE®, heavy-duty liquid formula (HDL).

Composition (in 2 Gallon Wash):

| | |
|---|---|
| 1 ppm perhydrolase variant | 470 ul 16100 ppm perhydrolase |
| S54V | variant S54V (16.1 mg/ml) |
| 1 ppm WT perhydrolase | 690 ul 11000 ppm WT perhydrolase |
| | (11 mg/ml) |
| 300 ppm C₁₂-C₁₅ E7 acetate | 2271 mg C₁₂-C₁₅-E7 acetate |
| 200 ppm triacetin | 1514 mg triacetin (~1.3 ml) |
| 2.25 mM hydrogen peroxide | 1.94 ml 30% H2O2 |
| 75 ppm PB1 | 568 mg PB1 (0.75 mM ~pH 10) |
| 20 ppm citrate | 1.01 ml 15% citric acid (0.1 mM ~pH 2) |
| 100 ppm LAS | 3.98 ml 19% LAS pH 8.5 (NaOH |
| | neutralized) |
| 80 ppm ZPB | 606 mg ZPB |
| 6 gpg hardness | up to 4.5 ml of 10,000 gpg 3:1 Ca:Mg |
| | (water hardness stock) |
| Benchmark: 1540 ppm | 11.66 g TIDE ® HDL |
| TIDE ® HDL | |

Performance:

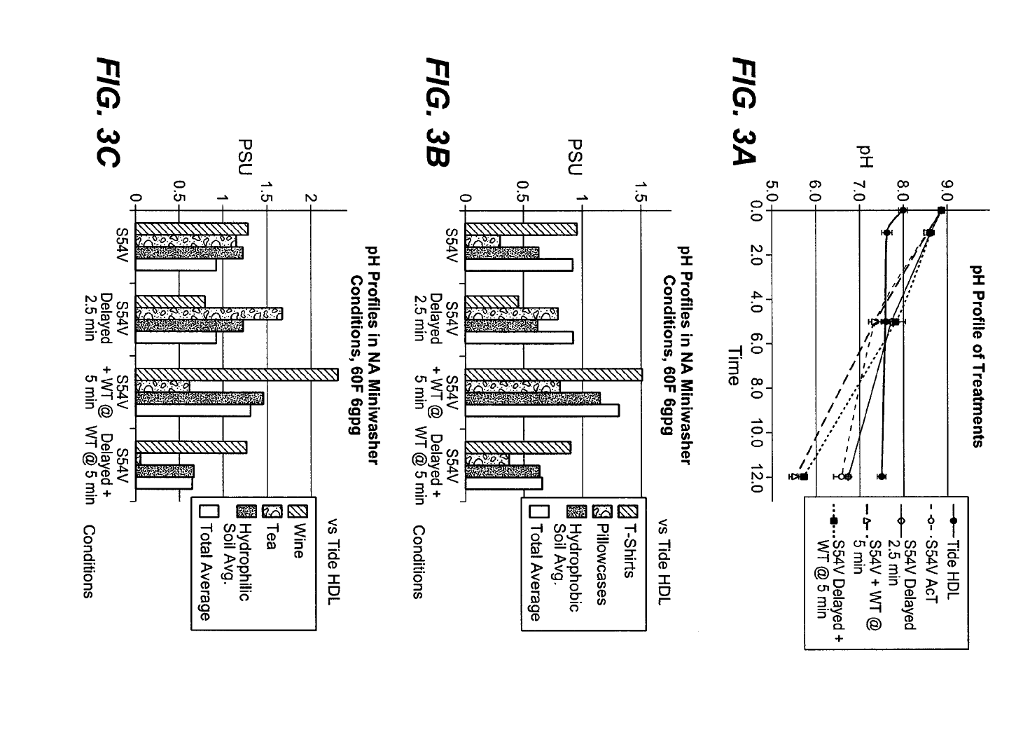

FIG. 3 shows the pH profiles generated by the various conditions. The addition of the perhydrolase with high hydrolysis activity (WT) was required to generate sufficient acid to lower the pH below 6. Delaying the addition of the high efficiency perhydrolase (S54V) only marginally slowed the pH drop, but had a large impact on cleaning performance. Allowing the high efficiency perhydrolase to react with the substrates for 5 minutes, generating peracetic acid at optimal activity conditions, then dropping the pH with a high hydrolysis activity enzyme was found to generate the desired pH profile and best cleaning performance on dingy and wine stains.
C. Optimization of Enzyme Parameters for Optimal Performance

Enzyme and substrate parameters were optimized using a statistical experimental design. The method set forth in Example 2, part A for testing detergent performance in small-scale was used to test substrate and enzyme parameters on cleaning performance. Cleaning was assessed on consumer dingy T-shirts and pillowcases, and prepared tea and wine stains. Four sets of five treatment, three replicate experiments were conducted comparing various amounts of a high efficiency perhydrolase (S54V) with various amounts and delays in addition of triacetin. Treatments were compared to and normalized against commercial TIDE®, HDL formula.

| | | | Triacetin | |
|---|---|---|---|---|
| Run No. | AcT S54V | Triacetin | Delay | Code |
| 1 | 1 | 300 | 0 | 1B |
| 2 | 1 | 100 | 0 | 1C |
| 3 | 0.55 | 300 | 3 | 1D |
| 4 | 0.1 | 200 | 0 | 1E |
| 5 | 0.325 | 150 | 0 | 2B |
| 6 | 0.1 | 100 | 3 | 2C |
| 7 | 0.325 | 250 | 0 | 2D |
| 8 | 0.1 | 100 | 3 | 2E |
| 9 | 0.775 | 150 | 3 | 3B |
| 10 | 0.1 | 300 | 0 | 3C |
| 11 | 0.1 | 100 | 0 | 3D |
| 12 | 0.55 | 200 | 3 | 3E |
| 13 | 1 | 300 | 3 | 4B |
| 14 | 0.775 | 250 | 0 | 4C |
| 15 | 1 | 100 | 3 | 4D |
| 16 | 0.1 | 300 | 3 | 4E |

Composition (in 2 Gallon Wash):

| | |
|---|---|
| 0.1-1 ppm perhydrolase | 0.1, 0.33, 0.55, 0.78, 1 ml 7570 |
| S54V | ppm perhydrolase S54V |
| 100-300 ppm triacetin | 757, 1136, 1514, 1893, 2271 mg |
| | triacetin |
| 300 ppm C₁₂-C₁₃ E9 acetate | 2271 mg C₁₂-C₁₃-E9 acetate |
| 2 mM hydrogen peroxide | 1.72 ml 30% H2O2 |
| 100 ppm PB1 | 757 mg PB1 (~pH 10) |
| 20 ppm citrate | 152 mg citric acid |
| 100 ppm LAS | 3.98 ml 19% LAS pH 8.5 (NaOH |
| | neutralized) |
| 80 ppm ZPB | 606 mg ZPB |
| 6 gpg hardness | up to 4.5 ml of 10,000 gpg 3:1 Ca:Mg |
| | (water hardness stock) |
| Benchmark: 1540 ppm | 11.66 g TIDE ® HDL |
| TIDE ® HDL | |

Performance:

The dependence of cleaning dingy soils, tea, and wine stains on enzyme and triacetin concentrations was determined. The use of three-minute delayed additions of triacetin to the composition during the wash cycle was found to make no significant impact on cleaning any of the stains. Cleaning of dingy T-shirts, tea, and wine stains were heavily dependent upon enzyme concentration, indicating that a minimum of 1 ppm of the highly efficient perhydrolase is required to convert most of the substrates to peracetic acid for bleaching and acid for lowering pH. Independence of cleaning of T-shirts and tea stains from triacetin concentrations indicates that triacetin above 100 ppm is unused in the current wash system, with only 1 ppm enzyme.

The dependence observed in cleaning of wine stains can be interpreted as a kinetic effect, in which the enzyme is generating peracetic or acetic acid faster at higher concentrations of triacetin and the wine stain is more sensitive earlier in the wash cycle.

### Example 3

### Determination of Substrate and its Effect on Cleaning Performance

In this Example, experiments conducted to determine the optimal substrate are described. The perhydrolase substrates in the dynamic pH detergent formula were used to generate peracid and acid for bleaching and lowering the pH over the course of the wash cycle.

Triacetin is a water-soluble substrate, with a high molar acid to weight ratio for generating large amounts of bulk solution peracetic and acetic acid. In other embodiments, surfactant esters find use in providing enhanced cleaning, as they combine surfactant properties with an ester that can be converted to peracetic acid by perhydrolase during cleaning Four surfactant esters were tested for their effect on cleaning of dingy T-shirt and pillowcase soils as well as prepared tea and wine stains. The four surfactant esters comprised of varying alkyl chain lengths with varying ethylene oxide chain lengths and an acetate ester attached to the terminal primary alcohol of the last ethoxylate.

The C₁₂-C₁₃ E9 acetate is composed of an alkyl chain with a distribution centering around 12 to 13 carbons, an ethoxylation distribution centering around 9 ethylene glycol units, and a terminal acetate. The C₁₂-C₁₅ E7 acetate is composed of a 12 to 15 carbon alkyl chain with 7 ethylene oxide units and an acetate. The C₉-C₁₁ E2.5 acetate is composed of a 9 to 11 carbon alkyl chain with 2 to 3 ethylene oxide units and an acetate. The C₉-C₁₁ E6 acetate is composed of a 9 to 11 carbon alkyl chain with 6 ethylene oxide units and an acetate.

The method described in Example 2, part A, for testing detergent performance in small-scale was used to test these substrates on cleaning performance using a five treatment, three replicate experimental design. Treatments were compared to and normalized against commercial TIDE®, heavy-duty liquid formula.

Composition (in 2 Gallon Wash):

| | |
|---|---|
| 1 ppm perhydrolase S54V | 1 ml 7570 ppm perhydrolase S54V |
| 300 ppm various | 2271 mg C₁₂-C₁₃-E9, C₁₂-C₁₅-E7, |
| surfactant esters | C₉-C₁₁-E2.5, C₉-C₁₁₋E6.5 acetates |
| 200 ppm triacetin | 1514 mg triacetin (~1.3 ml) |
| 2.25 mM hydrogen peroxide | 1.94 ml 30% H2O2 |
| 75 ppm PB1 | 568 mg PB1 (0.75 mM ~pH 10) |
| 20 ppm citrate | 152 mg citric acid (0.1 mM ~pH 2) |
| 100 ppm LAS | 3.98 ml 19% LAS pH 8.5 (NaOH |
| | neutralized) |
| 80 ppm ZPB | 606 mg ZPB |
| 6 gpg hardness | up to 4.5 ml of 10,000 gpg 3:1 Ca:Mg |
| | (water hardness stock) |
| Benchmark: 1540 ppm | 11.66 g TIDE ® HDL |
| TIDE ® HDL | |

Performance:

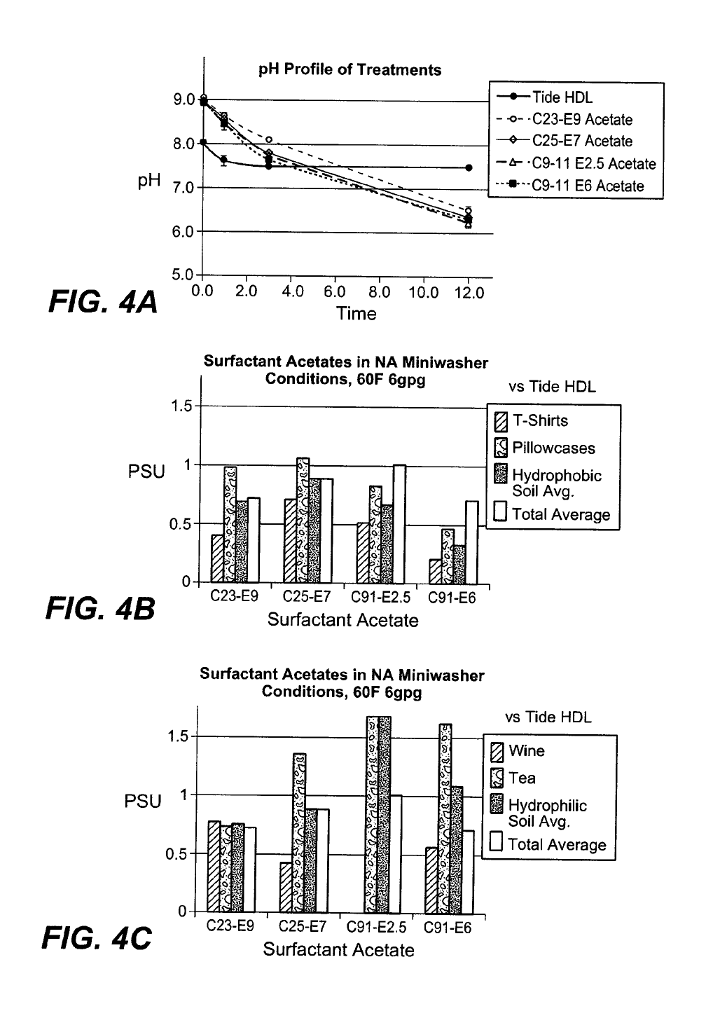

FIG. 4 shows the pH profiles generated by the various substrates. Any differences in perhydrolysis or hydrolysis of the substrates by the enzyme, or in molar acid to weight ratios did not significantly impact pH profiles. The C₁₂-C₁₅-E7 acetate did, however, provide slightly enhanced cleaning of consumer dingy T-shirts and pillowcases. The shorter substrates, C₉-C₁₁-E2.5 and C₉-C₁₁-E6 acetates, provided enhanced cleaning on the hydrophilic soils of tea and wine, likely due to their higher molar peracid to weight ratios. Regardless, all substrates in combination with enzyme performed well in cleaning tea and wine stains.

### Example 4

### Comparison of Dynamic pH Detergent Composition to Commercial Brands

In this Example, experiments conducted to compare dynamic pH detergent compositions are described. The method set forth in Example 2, part A, for testing detergent performance on a small scale was used to compare the cleaning performance of dynamic pH detergent compositions to commercial TIDE® brands. Cleaning was assessed on consumer dingy T-shirts and pillowcases, and prepared tea and wine stains. A five treatment, three replicate experiment was conducted comparing commercial Liquid TIDE® with Bleach Alternative, commercial TIDE® with Bleach granules, a dynamic pH composition containing the C₁₂-C₁₅-E7 acetate, a dynamic pH composition containing C₉-C₁₁-E2.5 acetate, and commercial TIDE® HDL formula as the benchmark. A protease was added to the dynamic pH detergent composition to equalize any advantage of commercial brands on protein containing soils such as consumer dingy articles. The low efficiency, high hydrolysis activity perhydrolase (WT) was added into the dynamic pH treatment wash cycle after a 5 minute delay to reproduce the optimal pH profile using current components. In these experiments, a serine protease ASP was also used.

Composition (in 2 Gallon Wash):

| | |
|---|---|
| 1 ppm ASP Variant R18 | 298 ul 25400 ppm ASP R18 |
| 1 ppm Perhydrolase S54V | 470 ul 16100 ppm Perhydrolase S54V |
| 1 ppm Perhydrolase WT | 690 ul 11000 ppm Perhydrolase WT at 5 |
| after 5 min delay | minutes into wash cycle |
| 300 ppm various esters | 2271 mg C₉-C₁₁-E2.5, C₁₂-C₁₅-E7 acetates |
| substrates | |
| 200 ppm triacetin | 1514 mg triacetin (~1.3 ml) |
| 2.25 mM hydrogen | 1.94 ml 30% H2O2 |
| peroxide | |
| 75 ppm PB1 | 568 mg PB1 (0.75 mM ~pH 10) |
| 20 ppm citrate | 1.01 ml 15% citric acid (0.1 mM ~pH 2) |
| 100 ppm LAS | 3.98 ml 19% LAS pH 8.5 (NaOH |
| | neutralized) |
| 80 ppm ZPB | 606 mg ZPB |
| 6 gpg hardness | up to 4.5 ml of 10,000 gpg 3:1 Ca:Mg |
| | (Water Hardness Stock) |
| Benchmarks: 1540 ppm | 11.66 g TIDE ® HDL |
| TIDE ® HDL | |
| 1540 ppm Liquid TIDE ® | 11.66 g LTBA |
| with Bleach Alternative | |
| (LTBA) | |
| 970 ppm Granular TIDE ® | 7.34 g TIDE ® with Bleach |
| with Bleach | |

Performance:

FIG. 5 shows the pH profiles generated by the various conditions. The dynamic pH composition, regardless of substrate, generated a linear pH profile from pH 9 to 5.5 through the wash cycle. The pH profile of the commercial TIDE® formulations dropped slightly after the addition of the test stains and soiled ballast, due to their inherent buffering capacity, but the pH remained constant through the entire wash cycle. The liquid TIDE® formulations maintained a wash pH of 7.5, while the granular TIDE® with bleach maintained a wash pH of 10.25. The dynamic pH detergent compositions performed significantly better than commercial TIDE® liquid formulations in cleaning consumer dingy T-shirts and pillowcases and prepared tea and wine stains. The best dynamic pH composition with the C₁₂-C₁₅-E7 acetate substrate performed equivalent to granular TIDE® with Bleach on both consumer dingy articles and tea and wine stains.

### Example 5

### Detergent Compositions

In the following Example, various detergent compositions are exemplified. In these formulations, the enzymes levels are expressed by pure enzyme by weight of the total composition and unless otherwise specified, the detergent ingredients are expressed by weight of the total compositions.

The following liquid laundry detergent compositions of the present invention are prepared.

| | I | II | III | IV | V |
|---|---|---|---|---|---|
| LAS | 12.0 | — | 4.0 | — | — |
| C₁₂-C₁₅ AE_{1.8}S | — | 2.0 | 3.0 | 8.0 | 5.0 |
| C₈-C₁₀ propyl dimethyl | 2.0 | 2.0 | 2.0 | 2.0 | 1.0 |
| amine | | | | | |
| C₁₂-C₁₄ alkyl dimethyl | — | — | — | — | 2.0 |
| amine oxide | | | | | |
| C₁₂-C₁₅ AS | — | 10.0 | — | 2.0 | 2.0 |
| CFAA | — | 5.0 | 4.0 | 4.0 | 3.0 |
| MCAEM | 12.0 | 6.0 | 15.0 | 20.0 | 15.0 |
| (Triacetin) | | | | | |
| C₁₂-C₁₈ Fatty acid | 8.0 | 6.0 | 2.0 | 2.0 | 2.0 |
| Citric acid (anhydrous) | 2.0 | 1.0 | 1.5 | 1.0 | 1.0 |
| DETPMP | 1.0 | 1.0 | 1.0 | 1.0 | 0.5 |
| Monoethanolamine | 8.0 | 6.0 | 3.0 | 3.0 | 2.0 |
| Percarbonate | 5.0 | 3.5 | — | 2.5 | — |
| Propanediol | 12.7 | 14.5 | 13.1 | 10. | 8.0 |
| Ethanol | 1.8 | 1.8 | 4.7 | 5.4 | 1.0 |
| Pectin lyase | — | — | — | 0.005 | — |
| Amylase | — | 0.002 | — | | — |
| Cellulase | — | — | 0.0002 | | 0.0001 |
| Lipase | 0.1 | — | 0.1 | — | 0.1 |
| Protease A | 0.05 | 0.3 | 0.055 | 0.5 | 0.2 |
| Aldose oxidase | — | — | 0.3 | — | 0.003 |
| PAAC | 0.01 | 0.01 | — | — | — |
| DETBCHD | — | — | 0.02 | 0.01 | — |
| SRP1 | 0.5 | 0.5 | — | 0.3 | 0.3 |
| Boric acid | 2.4 | 2.4 | 2.8 | 2.8 | 2.4 |
| Sodium xylene sulfonate | — | — | 3.0 | — | — |
| DC 3225C | 1.0 | 1.0 | 1.0 | 1.0 | 1.0 |
| 2-butyl-octanol | 0.03 | 0.04 | 0.04 | 0.03 | 0.03 |
| DTPA | 0.5 | 0.4 | 0.35 | 0.28 | 0.4 |
| Brightener 1 | 0.18 | 0.10 | 0.11 | — | — |
| Perhydrolase | 0.05 | 0.3 | 0.08 | 0.5 | 0.2 |
| MCAEM | 3.0 | 8.0 | 12.0 | 1.5 | 4.8 |
| (C₁₂-C₁₃ E_{6.5} Acetate) | | | | | |

Balance to 100% perfume/dye and/or water

The pH of compositions (1)-(V) is about 9 to about 10 and is adjusted to such pH by adding sodium hydroxide.

In addition, the following hand dish liquid detergent compositions of the present invention are prepared.

| | I | II | III | IV | V | VI |
|---|---|---|---|---|---|---|
| C₁₂-C₁₅ AE_{1.8}S | 20.0 | 12.0 | 10.0 | — | 10.0 | 10.0 |
| LAS | — | — | — | 5.0 | 5.0 | 8.0 |
| Paraffin sulfonate | — | — | — | 12.0 | — | — |
| C₁₀-C₁₈ alkyl dimethyl | 5.0 | 3.0 | 5.0 | — | — | — |
| amine oxide | | | | | | |
| Betaine | 3.0 | — | 1.0 | 3.0 | 1.0 | — |
| C₁₂ poly-OH fatty acid | — | — | — | 3.0 | — | 1.0 |
| amide | | | | | | |
| C₁₄ poly-OH fatty acid | — | 1.5 | — | — | — | — |
| amide | | | | | | |
| MCAEM | 12.0 | 15 | 18 | 8 | 15 | 20.0 |
| (Triacetin) | | | | | | |
| DTPA | — | — | — | — | 0.2 | — |
| Tri-sodium citrate | 0.25 | — | — | 0.7 | — | — |
| dihydrate | | | | | | |
| Diamine | 1.0 | 5.0 | 7.0 | 1.0 | 5.0 | 7.0 |
| MgCl₂ | 0.25 | — | — | 1.0 | — | — |
| Protease A | 0.02 | 0.01 | 0.02 | 0.01 | 0.02 | 0.05 |
| Amylase | 0.001 | — | — | 0.002 | — | 0.001 |
| Aldose oxidase | — | — | — | 0.02 | 0.05 | 0.01 |
| Sodium cumene | — | — | — | 2.0 | 1.5 | 3.0 |
| sulphonate | | | | | | |
| PAAC | 0.01 | 0.01 | 0.02 | — | — | — |
| DETBCHD | — | — | — | 0.01 | 0.02 | 0.01 |
| PB1 | 1.5 | 2.8 | 1.2 | — | — | — |
| Perhydrolase | 0.02 | 0.01 | 0.03 | 0.01 | 0.02 | 0.05 |
| MCAEM | 3.4 | 2.8 | 4.0 | 2.6 | 4.6 | 6.8 |
| (C₁₁ E9 Acetate) | | | | | | |

Balance to 100% perfume/dye and/or water

The pH of Compositions (I)-(VI) is about 8 to about 9 and is adjusted to such pH by adding sodium hydroxide.

The following liquid automatic dishwashing detergent compositions of the present are also prepared.

| | I | II | III | IV | V |
|---|---|---|---|---|---|
| STPP | 16 | 16 | 18 | 16 | 16 |
| Potassium sulfate | — | 10 | 8 | — | 10 |
| 1,2 propanediol | 6.0 | 0.5 | 2.0 | 6.0 | 0.5 |
| Boric acid | 4.0 | 3.0 | 3.0 | 4.0 | 3.0 |
| CaCl₂ dihydrate | 0.04 | 0.04 | 0.04 | 0.04 | 0.04 |
| MCAEM | 5.0 | 3.0 | 12.0 | 8.0 | 1.0 |
| (Triacetin) | | | | | |
| Protease B | 0.03 | 0.03 | 0.03 | 0.03 | 0.03 |
| Amylase | 0.02 | — | 0.02 | 0.02 | — |
| Aldose oxidase | — | 0.15 | 0.02 | — | 0.01 |
| Galactose oxidase | — | — | 0.01 | — | 0.01 |
| PAAC | 0.01 | — | — | 0.01 | — |
| DETBCHD | — | 0.01 | — | — | 0.01 |
| Perhydrolase | 0.1 | 0.03 | 0.05 | 0.03 | 0.06 |
| MCAEM | 1.0 | 0.5 | 1.0 | 1.0 | 0.5 |
| (C₁₄-C₁₅E₁₂ Acetate) | | | | | |

Balance to 100% perfume/dye and/or water

The pH of Compositions (I)-(V) is about 9 to about 10 and is adjusted to such pH by adding sodium hydroxide.

The following laundry compositions of present invention are also prepared. These compositions are in the form of granules or tablets in some preferred embodiments.

| Base Product | I | II | III | IV | V |
|---|---|---|---|---|---|
| C₁₄-C₁₅AS or TAS | 8.0 | 5.0 | 3.0 | 3.0 | 3.0 |
| LAS | 8.0 | — | 8.0 | — | 5.0 |
| C₁₂-C₁₅AE₃S | 0.5 | 2.0 | 1.0 | — | — |
| MCAEM | 12.0 | 15.0 | 10.0 | 18.0 | 12.0 |
| (Triacetin) | | | | | |
| QAS | — | — | — | 1.0 | 1.0 |
| Zeolite A | 5.0 | 8.0 | 6.0 | — | 5.0 |
| SKS-6 (dry add) | — | — | 4.0 | — | — |
| MA/AA | 2.0 | 2.0 | 2.0 | — | — |
| AA | — | — | — | — | 4.0 |
| 3Na citrate 2H₂O | — | 2.0 | — | — | — |
| Citric acid (anhydrous) | 2.0 | — | 1.5 | 2.0 | — |
| DTPA | 0.2 | 0.2 | — | — | — |
| EDDS | — | — | 0.5 | 0.1 | — |
| HEDP | — | — | 0.2 | 0.1 | — |
| PB1 | 3.0 | 4.8 | — | — | 4.0 |
| Percarbonate | — | — | 3.8 | 5.2 | — |
| NOBS | 1.9 | — | — | — | — |
| NACA OBS | — | — | 2.0 | — | — |
| TAED | 0.5 | 2.0 | 2.0 | 5.0 | 1.00 |
| BB1 | 0.06 | — | 0.34 | — | 0.14 |
| BB2 | — | 0.14 | — | 0.20 | — |
| Sulfate | 20.0 | 25.0 | 10.0 | 25.0 | 18.0 |
| Silicate | — | 1.0 | — | — | 3.0 |
| Protease B | 0.033 | 0.033 | — | — | — |
| Protease C | — | — | 0.033 | 0.046 | 0.033 |
| Lipase | — | 0.008 | — | — | — |
| Amylase | 0.001 | — | — | — | 0.001 |
| Cellulase | — | 0.0014 | — | — | — |
| Pectin lyase | 0.001 | 0.001 | 0.001 | 0.001 | 0.001 |
| Aldose oxidase | 0.03 | — | 0.05 | — | — |
| PAAC | — | 0.01 | — | — | 0.05 |
| Perhydrolase | 0.03 | 0.05 | 1.0 | 0.06 | 0.1 |
| MCAEM** | 2.0 | 5.0 | 12.0 | 3.5 | 6.8 |

Balance to 100% moisture/sodium sulfate and/or minors*
Perfume/dye, brightener/SRP1/Na carboxymethylcellulose/photobleach/MgSO₄/PVPVI/suds suppressor/high molecular PEG/Clay.
**MCAEM is selected from the group consisting of C₉-C₁₁E_{2.5} Acetate, [C₁₂H₂₅N(CH₃)(CH₂CH₂OAc)₂]⁺ Cl⁻, (CH₃)₂NCH₂CH₂OCH₂CH₂OAc, or mixtures thereof..

The following liquid laundry detergent formulations of the present invention are also prepared.

| | I | I | II | III | IV | V |
|---|---|---|---|---|---|---|
| LAS | 11.5 | 8.5 | 9.0 | — | 4.0 | — |
| C₁₂-C₁₅AE_{2.85}S | — | — | 3.0 | 18.0 | — | 12.0 |
| C₁₄-C₁₅E_{2.5} S | 8.5 | 11.5 | 3.0 | — | 12.0 | — |
| MCAEM | 3.2 | 3.2 | 3.0 | 2.0 | 2.0 | 1.0 |
| (Triacetin) | | | | | | |
| CFAA | — | — | — | 5.0 | — | 3.0 |
| TPKFA | 2.0 | 2.0 | — | 2.0 | 0.5 | 2.0 |
| Citric acid | 3.2 | 3.2 | 0.5 | 1.2 | 2.0 | 1.2 |
| (anhydrous) | | | | | | |
| Ca formate | 0.1 | 0.1 | 0.06 | 0.1 | — | — |
| Na formate | 0.5 | 0.5 | 0.06 | 0.1 | 0.05 | 0.05 |
| Na culmene | 4.0 | 4.0 | 1.0 | 3.0 | 1.2 | — |
| sulfonate | | | | | | |
| Borate | 0.6 | 0.6 | — | 3.0 | 2.0 | 3.0 |
| Ethanol | 2.0 | 2.0 | 1.0 | 4.0 | 4.0 | 3.0 |
| 1,2 propanediol | 3.0 | 3.0 | 2.0 | 8.0 | 8.0 | 5.0 |
| Mono- | 3.0 | 3.0 | 1.5 | 1.0 | 2.5 | 1.0 |
| ethanolamine | | | | | | |
| TEPAE | 2.0 | 2.0 | — | 1.0 | 1.0 | 1.0 |
| PB1 | 3.8 | 2.0 | 4.5 | 3.2 | 2.8 | 2.5 |
| Protease A | 0.03 | 0.03 | 0.01 | 0.03 | 0.02 | 0.02 |
| Lipase | — | — | — | 0.002 | — | — |
| Amylase | — | — | — | — | 0.002 | — |
| Cellulase | — | — | — | — | — | 0.0001 |
| Pectin lyase | 0.005 | 0.005 | — | | — | — |
| Aldose oxidase | 0.05 | — | — | 0.05 | — | 0.02 |
| Galactose oxidase | — | 0.04 | | | | |
| Perhydrolase | 0.03 | 0.05 | 0.01 | 0.03 | 0.08 | 0.02 |
| MCAEM | 3.2 | 4.6 | 1.8 | 3.5 | 6.2 | 2.8 |
| (C₁₂-C₁₅ E₆ | | | | | | |
| Acetate) | | | | | | |
| PAAC | 0.03 | 0.03 | 0.02 | — | — | — |
| DETBCHD | — | — | — | 0.02 | 0.01 | — |
| SRP 1 | 0.2 | 0.2 | — | 0.1 | — | — |
| DTPA | — | — | — | 0.3 | — | — |
| PVNO | — | — | — | 0.3 | — | 0.2 |
| Brightener 1 | 0.2 | 0.2 | 0.07 | 0.1 | — | — |
| Silicone antifoam | 0.04 | 0.04 | 0.02 | 0.1 | 0.1 | 0.1 |

Balance to 100% perfume/dye, and/or water

The pH of Compositions (I)-(V) is about 9 to about 10 and is adjusted to such pH by adding sodium hydroxide.

The following compact high density dishwashing detergent of the present invention are prepared:

| | I | II | III | IV | V | VI |
|---|---|---|---|---|---|---|
| STPP | — | 35.0 | 45.0 | — | — | 20.0 |
| 3Na citrate | 17.0 | — | — | 30.0 | 35.0 | — |
| 2H₂O | | | | | | |
| Silicate | 5.0 | 5.0 | 3.0 | — | 5.0 | 1.0 |
| Metasilicate | 2.5 | 4.5 | 4.5 | — | — | — |
| PB1 | — | — | 4.5 | — | — | — |
| PB4 | — | — | — | 5.0 | — | — |
| Percarbonate | 5.0 | 4.5 | — | — | 3.8 | 4.8 |
| BB1 | — | 0.1 | 0.1 | — | 0.5 | — |
| BB2 | 0.2 | 0.05 | — | 0.1 | — | 0.6 |
| MCAEM | 3.5 | 14.5 | 5.5 | 3.0 | 2.9 | 25.9 |
| (Triacetin) | | | | | | |
| HEDP | 1.0 | — | — | — | — | — |
| DETPMP | 0.6 | — | — | — | — | — |
| PAAC | 0.03 | 0.05 | 0.02 | — | — | — |
| Paraffin | 0.5 | 0.4 | 0.4 | 0.6 | — | — |
| Protease B | 0.072 | 0.053 | 0.053 | 0.026 | 0.059 | 0.01 |
| Amylase | 0.012 | — | 0.012 | — | 0.021 | 0.006 |
| Lipase | — | 0.001 | — | 0.005 | — | — |
| Pectin lyase | 0.001 | 0.001 | 0.001 | — | — | — |
| Aldose oxidase | 0.05 | 0.05 | 0.03 | 0.01 | 0.02 | 0.01 |
| Perhydrolase | 0.072 | 0.053 | 0.053 | 0.026 | 0.059 | 0.01 |
| MCAEM | 3.5 | 2.8 | 1.6 | 7.5 | 4.2 | 0.8 |
| (C₁₂-C₁₃ E_{6.5} | | | | | | |
| Acetate) | | | | | | |
| BTA | 0.3 | 0.2 | 0.2 | 0.3 | 0.3 | 0.3 |
| Poly- | 6.0 | — | — | — | 4.0 | 0.9 |
| carboxylate | | | | | | |
| Perfume | 0.2 | 0.1 | 0.1 | 0.2 | 0.2 | 0.2 |

Balance to 100% moisture/sodium sulfate, and/or minors*
*Brightener/dye/SRP1/Na carboxymethylcellulose/photobleach/MgSO₄/PVPVI/suds suppressor/high molecular PEG/clay.

The pH of compositions (I) through (VI) is from about 9.0 to about 10.0.

The following tablet detergent compositions of the present invention are prepared by compression of a granular dishwashing detergent composition at a pressure of 13 KN/cm² using a standard 12 head rotary press.

| | I | II | III | IV | V | VI | VII | VIII |
|---|---|---|---|---|---|---|---|---|
| STPP | — | 38.8 | 24.7 | 28.2 | — | 22.4 | 26.1 | 16.0 |
| 3Na citrate 2H₂O | 20.0 | — | — | — | 35.9 | — | — | — |
| Na carbonate | 5.0 | 1.0 | 3.0 | 2.4 | 1.0 | 5.0 | 2.0 | 3.0 |
| Silicate | 5.0 | 4.8 | 5.0 | 2.6 | 3.4 | 1.9 | 2.3 | 1.2 |
| Lipase | 0.001 | — | 0.01 | — | 0.02 | — | — | — |
| Protease B | 0.042 | 0.072 | 0.042 | 0.031 | — | — | — | — |
| Protease C | — | — | — | — | 0.052 | 0.023 | 0.023 | 0.029 |
| Perhydrolase | 0.01 | 0.08 | 0.05 | 0.04 | 0.052 | 0.023 | 0.023 | 0.029 |
| MCAEM | 2.8 | 6.5 | 4.5 | 3.8 | 4.6 | 2.8 | 2.8 | 2.8 |
| (C₉-C₁₁ E_{2.5} | | | | | | | | |
| Acetate) | | | | | | | | |
| Amylase | 0.012 | 0.012 | 0.012 | — | 0.015 | — | 0.017 | 0.002 |
| Pectin lyase | 0.005 | — | — | 0.002 | — | — | — | — |
| Aldose oxidase | — | 0.03 | — | 0.02 | 0.02 | — | 0.03 | — |
| PB1 | — | — | 3.8 | — | 7.8 | — | — | 8.5 |
| Percarbonate | 6.0 | 3.8 | — | 6.0 | — | 5.0 | 4.5 | — |
| BB1 | 0.2 | — | 0.5 | — | 0.3 | 0.2 | — | — |
| BB2 | — | 0.2 | — | 0.5 | — | — | 0.1 | 0.2 |
| MCAEM | 3.5 | 4.0 | 4.0 | 5.2 | 3.0 | 4.2 | 4.0 | 6.5 |
| (Triacetin) | | | | | | | | |
| PAAC | 0.01 | 0.01 | 0.02 | — | — | — | — | — |
| DETBCHD | — | — | — | 0.02 | 0.02 | — | — | — |
| TAED | — | — | — | — | — | 2.1 | — | 1.6 |
| HEDP | 1.0 | — | — | 0.9 | — | 0.4 | 0.2 | — |
| DETPMP | 0.7 | — | — | — | — | — | — | — |
| Paraffin | 0.4 | 0.5 | 0.5 | 0.5 | — | — | 0.5 | — |
| BTA | 0.2 | 0.3 | 0.3 | 0.3 | 0.3 | 0.3 | 0.3 | — |
| Polycarboxylate | 4.0 | — | — | — | 4.9 | 0.6 | 0.8 | — |
| PEG 400-30,000 | — | — | — | — | — | 2.0 | — | 2.0 |
| Glycerol | — | — | — | — | — | 0.4 | — | 0.5 |
| Perfume | — | — | — | 0.05 | 0.2 | 0.2 | 0.2 | 0.2 |

Balance to 100% moisture/sodium sulfate and/or minors*
*Brightener/dye/SRP1/Na carboxymethylcellulose/photobleach/MgSO₄/PVPVI/suds suppressor/high molecular PEG/clay.

The pH of compositions (I) through 7(VIII) is from about 9 to about 10.

The tablet weight of Compositions 7(I) through 7(VIII) is from about 20 grams to about 30 grams.

The following liquid hard surface cleaning detergent compositions of the present invention are prepared.

| | I | II | III | IV | V | VI | VII |
|---|---|---|---|---|---|---|---|
| MCAEM (Triacetin) | 7.0 | 5.9 | 8.5 | 12.5 | 15.5 | 6.4 | 12.5 |
| LAS | — | — | — | 0.8 | 0.8 | — | 0.8 |
| Sodium culmene sulfonate | 1.5 | 2.6 | — | 1.5 | 1.5 | 1.5 | 1.5 |
| Isachem ® AS | 0.6 | 0.6 | — | — | — | 0.6 | — |
| 3Na citrate 2H₂O | 0.5 | 0.56 | 0.5 | 0.6 | 0.75 | 0.5 | 0.75 |
| Fatty acid | 0.6 | 0.13 | 0.6 | 0.1 | 0.4 | 0.6 | 0.4 |
| 2-butyl octanol | 0.3 | 0.3 | — | 0.3 | 0.3 | 0.3 | 0.3 |
| PEG DME-2000 ® | 0.4 | — | 0.3 | 0.35 | 0.5 | — | — |
| PVP | 0.3 | 0.4 | 0.6 | 0.3 | 0.5 | — | — |
| MME PEG (2000) ® | — | — | — | — | — | 0.5 | 0.5 |
| Jeffamine ® ED-2001 | — | 0.4 | — | — | 0.5 | — | — |
| PAAC | — | — | — | 0.03 | 0.03 | 0.03 | — |
| DETBCHD | 0.03 | 0.05 | 0.05 | — | — | — | — |
| Protease B | 0.07 | 0.05 | 0.05 | 0.03 | 0.06 | 0.01 | 0.04 |
| Amylase | 0.12 | 0.01 | 0.01 | — | 0.02 | — | 0.01 |
| Lipase | — | 0.001 | — | 0.005 | — | 0.005 | — |
| Perhydrolase | 0.07 | 0.05 | 0.08 | 0.03 | 0.06 | 0.01 | 0.04 |
| MCAEM (C₁₂-C₁₅E6 | 3.5 | 5.6 | 4.8 | 5.3 | 3.6 | 8.0 | 4.7 |
| Acetate) | | | | | | | |
| Pectin lyase | 0.001 | — | 0.001 | — | — | — | 0.002 |
| PB1 | 2.5 | 4.6 | 1.8 | 3.8 | 3.2 | 1.8 | 2.8 |
| Aldose oxidase | 0.05 | — | 0.03 | — | 0.02 | 0.02 | 0.05 |

Balance to 100% perfume/dye, and/or water

The pH of Compositions (I) through (VII) is from about 8.5 to about 9.5 and is adjusted to such pH by adding sodium hydroxide.

All patents and publications mentioned in the specification are indicative of the levels of those skilled in the art to which the invention pertains. All patents and publications are herein incorporated by reference to the same extent as if each individual publication was specifically and individually indicated to be incorporated by reference.

Having described the preferred embodiments of the present invention, it will appear to those ordinarily skilled in the art that various modifications may be made to the disclosed embodiments, and that such modifications are intended to be within the scope of the present invention.

Those of skill in the art readily appreciate that the present invention is well adapted to carry out the objects and obtain the ends and advantages mentioned, as well as those inherent therein. The compositions and methods described herein are representative of preferred embodiments, are exemplary, and are not intended as limitations on the scope of the invention. It is readily apparent to one skilled in the art that varying substitutions and modifications may be made to the invention disclosed herein without departing from the scope and spirit of the invention.

The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

1. A composition comprising a sufficient amount of at least one enzyme and at least one substrate for said enzyme, sufficient to drop the pH of a wash liquor to at least about pH 7 or less.

2. The composition of claim 1, wherein said pH drop is to about pH 6 or less.

3. The composition of claim 1, wherein said enzyme is selected from hydrolases and oxidases.

4. The composition of claim 3, wherein said hydrolase is selected from perhydrolase, carboxylate ester hydrolase, thioester hydrolase, phosphate monoester hydrolase, phosphate diester hydrolase, thioether hydrolase, α-amino-acyl-peptide hydrolase, peptidyl-amino acid hydrolase, acyl-amino acid hydrolase, dipeptide hydrolase, peptidyl-peptide hydrolase, pepsin, pepsin B, rennin, trypsin, chymotrypsin A, chymotrypsin B, elastase, enterokinase, cathepsin C, papain, chymopapain, ficin, thrombin, fibrinolysin, renin, subtilisin, aspergillopeptidase A, collagenase, clostridiopeptidase B, kallikrein, gastrisin, cathepsin D, bromelin, keratinase, chymotrypsin C, pepsin C, aspergillopeptidase B, urokinase, carboxypeptidase A and B, aminopeptidase., lipase, pectin esterase, and chlorophyllase.

5. The composition of claim 3, wherein said hydrolase comprises a perhydrolase.

6. The composition of claim 3, wherein said oxidase is selected from aldose oxidase, galactose oxidase, cellobiose oxidase, pyranose oxidase, sorbose oxidase, hexose oxidase, and glucose oxidase.

7. The composition of claim 1, wherein said substrate comprises an ester moiety.

8. The composition of claim 7, wherein said substrate comprising said ester moiety is selected from ethyl acetate, triacetin, tributyrin, neodol esters, ethoxylated neodol acetate esters, formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid.

9. The composition of claim 7, wherein said substrate comprising said ester moiety has the formula R¹Oₓ[(R²)ₘ(R³)ₙ]ₚ,
wherein R¹ is H or a moiety that comprises a primary, secondary, tertiary or quaternary amine moiety, said R¹ moiety that comprises an amine moiety being selected from a substituted or unsubstituted alkyl, heteroalkyl, alkenyl, alkynyl, aryl, alkylaryl, alkylheteroaryl, and heteroaryl; or R¹ comprises from 1 to 50,000 carbon atoms, from 1 to 10,000 carbon atoms, or even from 2 to 100 carbon atoms;
each R² is an alkoxylate moiety, in one aspect of the present invention each R² is independently an ethoxylate, propoxylate or butoxylate moiety;
R³ is an ester-forming moiety having the formula: R⁴CO— wherein R⁴ may be H, substituted or unsubstituted alkyl, alkenyl, alkynyl, aryl, alkylaryl, alkylheteroaryl, and heteroaryl, in one aspect of the present invention, R⁴ may be a substituted or unsubstituted alkyl, alkenyl, or alkynyl moiety comprising from 1 to 22 carbon atoms, a substituted or unsubstituted aryl, alkylaryl, alkylheteroaryl, or heteroaryl moiety comprising from 4 to 22 carbon atoms or R⁴ may be a substituted or unsubstituted C₁-C₂₂ alkyl moiety or R⁴ may be a substituted or unsubstituted C₁-C₁₂ alkyl moiety; x is 1 when R¹ is H; when R¹ is not H, x is an integer that is equal to or less than the number of carbons in R¹, p is an integer that is equal to or less than x, m is an integer from 0 to 12 or even 1 to 12, and n is at least 1.

10. The composition of claim 8, wherein said composition comprises based on total composition weight, from about 0.01 to about 99.9 of said substrate comprising an ester moiety.

11. The composition of claim 10, wherein said composition comprises based on total composition weight, from about 0.1 to about 50 of said substrate comprising an ester moiety.

12. The composition of claim 1, further comprising a source of hydrogen peroxide and/or hydrogen peroxide.

13. The composition of claim 1, further comprising at least one adjunct ingredient.

14. The composition of claim 13, wherein said at least one adjunct ingredient is selected from surfactants, builders, chelating agents, dye transfer inhibiting agents, deposition aids, dispersants, additional enzymes, and enzyme stabilizers, catalytic materials, bleach activators, bleach boosters, preformed peracids, polymeric dispersing agents, clay soil removal/anti-redeposition agents, brighteners, suds suppressors, dyes, perfumes, structure elasticizing agents, fabric softeners, carriers, hydrotropes, processing aids and/or pigments.

15. A method for cleaning at least a portion of a surface and/or fabric comprising: the optional steps of washing and/or rinsing a surface and/or fabric; comprising said surface and/or fabric with the composition of claim 1 and/or a wash liquor comprising the composition of claim 1; and optionally washing and/or rinsing said surface and/or fabric.

16. The method of claim 15, wherein the pH of said wash liquor drops essentially linearly.

17. The method of claim 15, wherein said surface and/or fabric is exposed to said wash liquor having a pH of less than about 6.5 for a period of at least about 2 minutes.

18. A method for cleaning at least a portion of a surface and/or fabric comprising: the optional steps of washing and/or rinsing a surface and/or fabric; comprising said surface and/or fabric with the composition of claim 1 and/or a wash liquor comprising the composition of claim 1; and optionally washing and/or rinsing said surface and/or fabric, wherein said contacting occurs during a wash cycle.

19. The method of claim 18, wherein the pH of said wash liquor drops essentially linearly.

20. The method of claim 18, wherein the pH of said wash liquor drops to 6.5 or less within the last 25% to 50% of said wash cycle.

21. The method of claim 20, wherein said surface and/or fabric is exposed to said wash liquor having a pH of less than about 6.5 for a period of at least about 2 minutes.
